SEQUENCE LISTING (21 sequences)

SEQ ID NO: 1 - DNA, 22 bp, Artificial Sequence
  Synthetic
ctagcgttatatctcaaaatga

SEQ ID NO: 2 - DNA, 21 bp, Artificial Sequence
  Synthetic
cccatcacttcagcacataaa

SEQ ID NO: 3 - DNA, 21 bp, Artificial Sequence
  Synthetic
ttgacagcagccgattaagcg

SEQ ID NO: 4 - DNA, 21 bp, Artificial Sequence
  Synthetic
ctgacattattggtgcgacgg

SEQ ID NO: 5 - DNA, 21 bp, Artificial Sequence
  Synthetic
cgctagggctgtggaagtatt

SEQ ID NO: 6 - DNA, 21 bp, Artificial Sequence
  Synthetic
gttgtcccgggtaccagatat

SEQ ID NO: 7 - DNA, 21 bp, Artificial Sequence
  Synthetic
acattctccaccttgtgcttt

SEQ ID NO: 8 - DNA, 22 bp, Artificial Sequence
  Synthetic
catacaagcgagtgcaattaca

SEQ ID NO: 9 - DNA, 20 bp, Artificial Sequence
  Synthetic
tatatcccaacggagatggc

SEQ ID NO: 10 - DNA, 20 bp, Artificial Sequence
  Synthetic
atgttcctccaccaaaatcg

SEQ ID NO: 11 - DNA, 21 bp, Artificial Sequence
  Synthetic
cggcataagaaaagatggcac

SEQ ID NO: 12 - DNA, 20 bp, Artificial Sequence
  Synthetic
tcattcaccactgcttgaac

SEQ ID NO: 13 - DNA, 251 bp, Artificial Sequence
  Synthetic
ggtagcggtgatgatagccttatatttagtcggcagccgttggatattgatacgtcggttctgagcgataattttggttttgacgtaaagatttttaaccaagctgctccatatttttgttctaagtttttagttcaagtcgaggatagtctcttttttgttccccgatccacttaaactcttcgttaagtttggagcttccaaaacttcagatatcgaccttttacatgagatttttcaatctttcgtcg

SEQ ID NO: 14 - DNA, 249 bp, Artificial Sequence
  Synthetic
ccagcgcaagtggcggaaccacaggaaaccgatatagggtagtgccggaatctgagactctcacaccaaataagttggttttcgagaaagatccagacaagttcttgaagactatgggcaagggaatagctttggacttggcgggagttacccacaaaccgaaagttattaacgagccagggaaagtatcagtagaggtggcaatgaagattaatgccgcattgatggagctgtgtaagaaggttatgg

SEQ ID NO: 15 - DNA, 540 bp, Artificial Sequence
  Synthetic
atggacctatcgtttattattgtgcagatcctttccgcctcgtacaataatgacgtgacagcactttacactttgattaacgcgtataatagcgttgatgatacgacgcgctgggcagcgataaacgatccgcaagctgaggttaacgtcgtgaaggcttacgtagctactacagcgacgactgagctgcatagaacaattctcattgacagtatagactccgccttcgcttatgaccaagtggggtgtttggtgggcatagctagaggtttgcttagacattcggaagatgttctggaggtcatcaagtcgatggagttattcgaagtgtgtcgtggaaagaggggaagcaaaagatatcttggatacttaagtgatcaatgcactaacaaatacatgatgctaactcaggccggactggccgcagttgaaggagcagacatactacgaacgaatcatctagtcagtggtaataagttctctccaaatttcgggatcgctaggatgttgctcttgacgctttgttgcggagcactataa

SEQ ID NO: 16 - DNA, 20 bp, Artificial Sequence
  Synthetic
agtacgtaacggggcagaat

SEQ ID NO: 17 - DNA, 20 bp, Artificial Sequence
  Synthetic
acctgcttcatgagagcact

SEQ ID NO: 18 - DNA, 27 bp, Artificial Sequence
  Synthetic
aagtgctctagttaaggtcaggagtga

SEQ ID NO: 19 - DNA, 25 bp, Artificial Sequence
  Synthetic
gtattggactacctttcgggaaaat

SEQ ID NO: 20 - DNA, 20 bp, Artificial Sequence
  Synthetic
tcctctggacaatggatgga

SEQ ID NO: 21 - DNA, 20 bp, Artificial Sequence
  Synthetic
cttgcatccctcagcacctt

(19) United States
(12) Patent Application Publication
(10) Pub. No.: US 2024/0090512 A1
(43) Pub. Date: Mar. 21, 2024

(54) RNAI NANOPARTICLES AND METHODS OF USING SAME IN AGRICULTURE

(71) Applicants: YISSUM RESEARCH DEVELOPMENT COMPANY OF THE HEBREW UNIVERSITY OF JERUSALEM LTD., Jerusalem (IL); TECHNION RESEARCH & DEVELOPMENT FOUNDATION LIMITED, Haifa (IL)

(72) Inventors: Oded SHOSEYOV, Shoham (IL); Avi SCHROEDER, Haifa (IL); Aviram AVITAL, Haifa (IL); Noy SADOT MUZIKA, Rehovot (IL); Zohar Lily PERSKY, Beit Elazary (IL)

(73) Assignees: YISSUM RESEARCH DEVELOPMENT COMPANY OF THE HEBREW UNIVERSITY OF JERUSALEM LTD., Jerusalem (IL); TECHNION RESEARCH & DEVELOPMENT FOUNDATION LIMITED, Haifa (IL)

(21) Appl. No.: 18/273,357

(22) PCT Filed: Jan. 20, 2022
(86) PCT No.: PCT/IL2022/050086

§ 371 Date: Jul. 20, 2023

Related U.S. Application Data
(60) Provisional application No. 63/139,904, filed on Jan. 21, 2021.

(51) Int. Cl. A01N 63/60; A01N 25/12; A01P 1/00

(52) U.S. Cl. CPC A01N 63/60; A01N 25/12; A01P 1/00

(57) ABSTRACT

The present invention provides a nanoparticle including: (a) an amphiphilic co-polymer including an ionizable polymer covalently bound to a hydrophobic domain; and a polynucleotide comprising 60 to 500 nucleobases. Further provided are compositions including the nanoparticle of the invention, and methods of using same.

### CROSS-REFERENCE TO RELATED APPLICATIONS

This application claims the benefit of priority of U.S. Provisional Patent Application No. 63/139,904, titled “RNAI NANOPARTICLES AND METHODS OF USING SAME IN AGRICULTURE”, filed Jan. 21, 2021, the contents of which are incorporated herein by reference in their entirety.

### FIELD OF INVENTION

The present invention is in the field of agricultural compositions, and specifically to formulations for delivery of agriculturally active agents, such as gene silencing polynucleotides.

### BACKGROUND

RNA interference (RNAi) is a gene regulation mechanism also known as post-transcriptional gene silencing (PTGS) in plants. This mechanism is sequence-specific due to its dependency on double strand RNA (dsRNA) precursors to trigger the process. In plants, RNase III-like enzyme, Dicer-like (DCL) protein, processes dsRNA into 21-24 base pair (bp) short interfering RNA (siRNA) which guide transcript recognition and degradation downstream. Unlike in mammalian cells, DCL protein preferably processes long dsRNA precursors followed by an apparent siRNA mobility between plant cells via plasmodesmata, hence, RNAi is attributed as potentially successful in applying systemic resistance to plant viruses. In order to utilize RNAi, dsRNA needs to enter cells' cytoplasm via a delivery pathway. Foliar application of naked dsRNA dangers its stability and results in a short silencing period, while standard delivery methods (e.g., Agrobacterium and/or DNA vectors) hold limitations of their own, for example, suppression of off-target genes.

The viral grapevine leafroll disease (GLD) is a non-limiting example for the need of agriculturally acceptable compositions useful for delivery of gene silencing polynucleotides. The wine industry in both ancient and modern times depends greatly on healthy vines and fine grapes. In recent decades, GLD pose a major threat on wine production around the globe by reducing crop yield and hampering berry quality indices such as cluster size, pH, sugar level and color, thus leading to major economic impact. Among various viruses associated with GLD, grapevine leafroll associated virus 3 (GLRaV-3) is the most prevalent and severe strain inducing strong symptoms of the disease as well as decreasing plant vigor and longevity. In New Zealand, GLRaV-3 strongly delays the onset of ripening for Sauvignon blanc berries and reduces their titratable acidity. In Benton Harbor, Michigan, USA, yield per vine along with soluble solids content were damaged in infected Cabernet Franc cultivar in comparison to healthy vines. GLRaV-3 belongs to Ampelovirus genus and consists of helical monopartite, positive sense, single stranded RNA genome nearly 18.5 kb in size. It contains 12 open reading frames coding for replication and structure related proteins such as RNA dependent RNA polymerase (RdRp) and coat protein (CP), respectively, among other essential proteins. Despite practical strategies implemented for managing GLD manifested by documenting, mapping and uprooting infected vines through control of mealybug vector and up to provision of certified planting material, most of them were not effective considering the challenges in controlling virus transmission and distribution.

There is still a great need for new technological approaches in order to deliver polynucleotides (e.g., gene silencing polynucleotides) in an agriculturally acceptable form.

### SUMMARY

In some embodiments, the present invention is directed to a delivery platform for long dsRNA based on a polycationic nanoparticle (NP).

The present invention is based, in part, on the findings that dsRNA-PEI NPs described herein achieved knockdown of a pathogenic agent (e.g., GLRaV-3) in consecutive field experiment following foliar administration.

The present invention is also based, in part, on the findings that synthesis of the NPs described herein is facile, rapid, and scalable resulting in stable NPs in ambient conditions.

The present invention is also based, in part, on the findings that the NPs provided herein present a passive delivery through leaves (e.g., grapevine leaves) transportation system alongside sequence protection from nuclease degradation.

Therefore, the present invention, in some embodiments, discloses a delivery platform for long dsRNA based on lipid-modified Polyethylenimine (lmPEI) NPs for efficient systemic treatment of viral infections, including but not limited to GLD induced by GLRaV-3.

According to a first aspect, there is provided a nanoparticle comprising: (a) an amphiphilic co-polymer comprising an ionizable polymer covalently bound to a hydrophobic domain; and (b) a polynucleotide comprising 60 to 500 nucleobases; wherein the ionizable polymer comprises an amine group; wherein a nitrogen to phosphate (N:P) molar ratio within the nanoparticle ranges from 2:1 to 7:1, wherein the polynucleotide is non-covalently bound to the ionizable polymer, and wherein the hydrophobic domain comprises an alkyl chain having a length sufficient to stabilize the nanoparticle in an aqueous solution for a time period of at least 1 hour.

According to another aspect, there is provided a composition comprising a plurality of nanoparticles disclosed herein, and an agriculturally acceptable carrier.

According to another aspect, there is provided a method for introducing a polynucleotide to a plant, the method comprising contacting the plant or a part thereof with a therapeutically effective amount of: (a) the nanoparticle disclosed herein; or (b) the composition disclosed herein, thereby introducing a polynucleotide to the plant.

According to another aspect, there is provided a method for preventing or treating a viral infectious disease in a plant, the method comprising contacting the plant or a part thereof with a therapeutically effective amount of: (a) the nanoparticle disclosed herein; or (b) the composition disclosed herein, thereby preventing or treating a viral infectious disease in the plant.

In some embodiments, the alkyl chain comprises between 10 and 14 carbon atoms.

In some embodiments, the nanoparticle has a particle size between 100 nm and 500 nm.

In some embodiments, the nanoparticle has a particle size between 150 nm and 350 nm.

In some embodiments, the amine group is any one of a primary amine group, a secondary amine group, a tertiary amine group, or any combination thereof.

In some embodiments, the ionizable polymer is polyethyleneimine (PEI).

In some embodiments, the PEI comprises a branched PEI.

In some embodiments, the branched PEI comprises a branched alkylated PEI.

In some embodiments, the branched alkylated PEI comprises an alkyl chain of 12 carbon atoms at most.

In some embodiments, the nanoparticle further comprises a biologically active agent.

In some embodiments, non-covalently bound is electrostatically bound.

In some embodiments, the polynucleotide comprises 100 to 350 nucleobases.

In some embodiments, the polynucleotide comprises a plurality of polynucleotide types.

In some embodiments, the polynucleotide comprises RNA.

In some embodiments, the RNA comprises a double stranded RNA (dsRNA).

In some embodiments, the RNA comprises at least 70% complementarity to any one of: (i) at least one RNA molecule derived from a pathogen; and (ii) at least one RNA molecule derived from a plant cell.

In some embodiments, the pathogen is a plant pathogen.

In some embodiments, the pathogen is a virus.

In some embodiments, the plurality of nanoparticles is characterized by a polydispersity index (PDI) ranging from 1 to 1.5.

In some embodiments, the plurality of nanoparticles is characterized by a mean Zeta potential ranging from −5 mV to 40 mV.

In some embodiments, the carrier is selected from the group consisting of: a solvent, a surfactant, a dispersant, a sticking agent, a spreading agent, a synergist, a penetrant, a compatibility agent, a buffer, a defoaming agent, a thickener, a drift retardant, and any combination thereof.

In some embodiments, the composition is formulated for administration by spraying, drenching, dipping, soaking, injecting, or any combination thereof.

In some embodiments, the viral infectious disease comprises grapevine leafroll disease (GLD).

In some embodiments, the viral disease is induced by a virus belonging to the genus Ampelovirus.

In some embodiments, the viral disease is induced by a virus selected from the group consisting of grapevine leafroll associated viruses (GLRaV).

In some embodiments, the viral disease is induced by the virus GLRaV-3.

In some embodiments, the treating comprises reducing a titer of a virus inducing the viral infectious disease in the plant or a part thereof.

In some embodiments, the treating comprises reducing any one of: number of curled leaves of the plant, rate of downward curling or cupping of leaves of the plant, and a combination thereof.

In some embodiments, the contacting comprises spraying, drenching, dipping, soaking, injecting, or any combination thereof, the plant or the part thereof.

In some embodiments, the plant part comprises foliage of the plant.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE FIGURES

FIGS. 1A-1F include micrographs and graphs showing dsRNA-lmPEI nanoparticles. (1A) A scheme of an illustration of nanoparticles synthesis including both lapidated tail conjugate and formulation. (1B) A cryoTEM image presenting dsRNA-lmPEI nanoparticle with inner ordered domains and its relevant fast Fourier transformation measurement of inter-fiber spacing (7.3±2 mm) from dsRNA center of mass to another. (1C) A graph showing nanoparticles' Zeta potential (N=3) at different N:P ratios. (1D) A micrograph of a gel electrophoresis examination of dsRNA binding at different N:P ratios (2% agarose, 100 V, 35 minutes). (1E) A graph showing nanoparticles size distribution by intensity measured by dynamic light scattering. (IF) A graph showing nanoparticles' stability at room temperature, 25 mM sodium acetate, pH=5.2 over 40 days.

FIGS. 2A-2D include images, micrographs and graphs showing particle penetration and biodistribution. (2A) Distribution of Cy5-labeled particles within vine leaves after a 2-h administration via spray or immersion (scale bar—1 mm). (2A) Particle accumulation is observed within leaf veins after 2 h, marked with arrows in the upper middle inset (scale bar—500 μm). (2B) Vine leaf's HR-SEM image shows multiple stomata on the leaf surface (right panel, emphasized by arrows; scale bar=40 μm). Open stomate dimension measured 6.105 μm wide and a 16.14 μm long, being a possible route for dsRNA-lmPEI particle penetration into the plant (left panel; scale bar=5 μm). (2C) Vine seedlings' leaf was submerged in an aqueous solution of Gd-conjugated particles, for 72 h. Gadolinium concentration was quantified in plant tissues above or below the administration point. (2D) Uptake and accumulation of lipidated particles was recorded 3 h after administration to roots of transgenic Arabidopsis expressing plasma membrane localized GFP (left panel). Particle uptake increased by 7.35-fold for lipidated particles in comparison to particles that lack lipid tail, indicating the effect of the lipid presence in formulation facilitates uptake into plant cells (N=4, right panel). Results are shown as mean±SD. Ordinary two-way ANOVA test was used for the statistical analysis of (D). ns—not significant, ****p<0.0001.

FIGS. 3A-3G include a micrograph, an illustration, and vertical bar graphs, related to particle efficacy. (3A) Gel image implies that the lmPEI carrier can protect dsRNA from RNase A activity (2% agarose, 100 mV, 35 minutes). When naked, RNA sequence is degraded by RNase A (third well to the left) as opposed to maintaining its integrity when complexed with lmPEI in particle form (arrows). Moreover, dsRNA release from complexes is identical both with and without RNase A activity and inhibition (second and fourth well to the right). (3B) Infection severity scoring throughout 2020 field experiment shows delayed GLD symptoms in multi-dose treated vines in comparison to single dose. (3C) An illustration of grapevine leafroll associated virus 3 open reading frames with transcriptional and structural RNAi targets (dashed lines). (3D) Compared to untreated infected vines, GLRaV3 expression is reduced after a single administration of particles in 2018 field experiment. Knockdown effect is apparent within shoot tissue distant from immersion treatment point. (3E) Respectively, change in administration method to canopy spraying managed to retain virus down-regulation three weeks post treatment (PT). (3F-3G) Grape quality parameters values of Brix (3F) and berry weight (3G) acquired after 2020 harvest indicate multiple treatments are preferable over a single treatment in recovering treated vines' berries and suggests multiple administrations may be needed to fully recover fruit quality. Results are shown as mean±SD. Ordinary one-way ANOVA tests were used for statistical analysis of 3D, 3F and 3G. ns—not significant, *p<0.05, ***p<0.001, ****p<0.0001.

FIG. 4 includes a vertical bar graph showing dsRNA-lmPEI encapsulation efficiency.

FIG. 5 includes a micrograph of a gel electrophoresis analysis showing Heparin release assay.

FIG. 6 includes vertical bar graphs showing berries pH 3, 5, and 8 weeks post-treatment (PT) in the 2019 experiment.

FIG. 7 includes vertical bar graphs showing berries tannin index 3, 5, and 8 weeks post-treatment (PT) in the 2019 experiment.

FIG. 8 includes vertical bar graphs showing berries total acid content 3, 5, and 8 weeks post-treatment (PT) in the 2019 experiment.

FIG. 9 includes vertical bar graphs showing berries color density 3, 5, and 8 weeks post-treatment (PT) in the 2019 experiment.

FIG. 10 includes vertical bar graphs showing berries softness ratio 3, 5, and 8 weeks post-treatment (PT) in the 2019 experiment.

FIGS. 11A-11B include micrographs and graphs showing fast Fourier transform (FFT) and radial integration of two samples; sample (11A) and Sample 2 (11B).

FIG. 12 includes fluorescent micrographs showing free Cy5 biodistribution in immersed or sprayed leaves. Scale bar=1 mm.

FIG. 13 includes a vertical bar graph showing GLRaV3 relative expression in 2019 field experiment.

FIG. 14 includes a vertical bar graph showing GLRaV3 relative expression throughout 2020 field experiment.

FIG. 15 includes a table showing infection severity scoring.

FIGS. 16A-16B include images showing representations of field experiments administration methods: 2018 shoot immersion (16A) and 2019 canopy spraying (16B).

FIG. 17 includes a vertical bar graph showing fluorescence quantification of particles' average intensity and number following a 2 hours immersion with Cy5 labeled dsRNA-lmPEI using Imaris Software.

FIG. 18 includes an illustration showing a partial energy minimized molecular mechanics model of the nanoparticles disclosed herein.

FIGS. 19A-19B include fluorescent micrographs showing roots of transgenic Arabidopsis expressing plasma membrane localized GFP at time zero (t=0; 19A) and after 3 hours (t=3; 19B). Roots were incubated in the presence of non-lipidated particles (negative control of 2D). Scale bar=50 μm.

FIGS. 20A-20D include graphs and a table showing ¹HNMR validation for lipid tail conjugation to branched PEI. (20A) Neat branched EPI; (20B) Neat epoxide; (20C) Purified ImPEI. (20D) Table summarizing functional groups, ¹HNMR chemical shifts (ppm), and marks, presented in 20A-20C.

FIG. 21 includes micrographs showing N:P ratio determination changes when altering branched PEI batch LOT number.

FIG. 22 includes a vertical bar graph showing Lipid chain length effect on Cy5/GFP ratio (equivalent to particle uptake).

FIGS. 23A-23B include graphs showing mean diameter (23A) and Zeta potential (23B) tested at three temperatures for a period of 14 days.

### DETAILED DESCRIPTION

### Nanoparticle

According to some embodiments, there is provided a nanoparticle comprising an amphiphilic co-polymer. In some embodiments, the amphiphilic co-polymer comprises an ionizable polymer covalently bound to a hydrophobic domain. In some embodiments, the amphiphilic co-polymer is or comprises a graft-copolymer. In some embodiments, the ionizable polymer comprises an amine group.

In some embodiments, the length of the hydrophobic domain of the amphiphilic co-polymer substantially predetermines a size of the nanoparticle of the invention, wherein the size is as described herein. In some embodiments, a weight ratio between the hydrophobic domain and the ionizable polymer predetermines the size, polynucleotide loading and/or stability of the nanoparticle of the invention. In some embodiments, the hydrophobic domain has a length sufficient to stabilize the nanoparticle. In some embodiments, the hydrophobic domain of the amphiphilic co-polymer has a length sufficient so as to result in a stable nanoparticle. In some embodiments, a stable nanoparticle is referred to a physical or chemical stability of the nanoparticle of the invention. In some embodiments, a stable nanoparticle is substantially devoid of disintegration. In some embodiments, a stable nanoparticle is substantially devoid of polynucleotide leakage therefrom. In some embodiments, a stable nanoparticle is substantially devoid of disintegration in a solution (e.g., an aqueous solution). In some embodiments, a stable nanoparticle is substantially devoid of aggregation.

In some embodiments, a nanoparticle of the invention is referred to as stable, when at least 80%, at least 85%, at least 90%, at least 95%, at least 99%, by weight of the particles retain at least 90% of the particle size, including any range therebetween. In some embodiments, a nanoparticle of the invention is referred to as stable, when at least 80%, at least 85%, at least 90%, at least 95%, at least 99%, by weight of the particles remain at least 90% of the particle size within a solution (e.g., an aqueous solution) for a time period of at least 1 h, at least 3 h, at least 5 h, at least 10 h, at least 24 h, at least 2 d, at least 10 d, at least 20 d, at least 1 m, at least 6 m, at least 1 year, including any value and range therebetween. Each possibility represents a separate embodiment of the invention.

In some embodiments, a nanoparticle of the invention is referred to as stable, when at least 80%, at least 85%, at least 90%, at least 95%, at least 99%, by weight of the particles retain at least 80% of the initial polynucleotide content.

In some embodiments, a nanoparticle of the invention is referred to as stable, when at least 80%, at least 85%, at least 90%, at least 95%, at least 99%, by weight of the nanoparticles stably encapsulate the polynucleotide therewithin.

In some embodiments, the hydrophobic domain comprises an alkyl group (branched or linear). In some embodiments, the alkyl group is an alkyl chain comprising between 10 and 27, between 10 and 12, between 12 and 13, between 13 and 14, between 14 and 15, between 15 and 16, between 16 and 17, between 17 and 19, between 10 and 20, between 12 and 25, between 15 and 22, between 17 and 24, between 19 and 25, or between 25 and 27 carbon atoms, including any range between. Each possibility represents a separate embodiment of the invention.

A skilled artisan will appreciate that the exact number of carbon atoms in the alkyl chain (or alkyl group) may vary, depending on the chemical composition and molecular weight of the ionizable polymer.

In some embodiments, the ionizable polymer comprises a primary amine group, a secondary amine group, a tertiary amine group, or any combination thereof. In some embodiments, the ionizable polymer is capable of undergoing ionization (positive ionization) within a solution having a pH value below the pKa value of the amine group of the ionizable polymer. In some embodiments, the ionizable polymer is capable of undergoing protonation within a solution having a pH value below the pKa value of the amine group of the ionizable polymer. In some embodiments, at least 50% by weight of the ionizable polymer is positively charged (or protonated) within a solution having a pH value below the pKa value of the amine group of the ionizable polymer. In some embodiments, the ionizable polymer is a polycationic polymer. In some embodiments, the ionizable polymer undergoes multiple protonation within a solution, wherein the solution is as described herein.

In some embodiments, the ionizable polymer comprises a polycation. In some embodiments, the ionizable polymer comprises a polyamine. In some embodiments, the ionizable polymer comprises any one of a polylysine, a polyarginine, a polyhistidine, chitosan, and polyethyleneimine (PEI) or any combination thereof.

In some embodiments, the ionizable polymer comprises polyethyleneimine (PEI).

In some embodiments, the PEI comprises a linear PEI. In some embodiments, the PEI comprises a branched PEI. In some embodiments, the PEI comprises a conjugated PEI. In some embodiments, the PEI comprises branched and alkylated PEI. In some embodiments, the branched alkylated PEI is prepared from a branched PEI having a number average molar mass (Mn) of about 600 g/mol (PEI₆₀₀).

In some embodiments, the amphiphilic co-polymer of the invention comprises a branched alkylated PEI. In some embodiments, the branched alkylated PEI comprises an alkyl chain having between 12 and 16 carbon atoms. In some embodiments, the branched alkylated PEI comprises an alkyl chain having 14 carbon atoms at most. In some embodiments, there is provided a nanoparticle comprising a branched conjugated PEI₆₀₀.

In some embodiments, PEI comprises or is a lipid-modified PEI (lmPEI).

The terms “PEI” and “lmPEI” are used herein interchangeably.

As used herein, the term “polymer” refers to molecule comprising at least 5 repeating units (or monomers), wherein the repeating units maybe the same or different (e.g. same or different amino acids).

In some embodiments, the branched alkylated PEI comprises an alkyl chain of 14 carbon atoms at most, 13 carbon atoms at most, 12 carbon atoms at most, 11 carbon atoms at most, 10 carbon atoms at most, 9 carbon atoms at most, 8 carbon atoms at most, 7 carbon atoms at most, 6 carbon atoms at most, 5 carbon atoms at most, 4 carbon atoms at most, 3 carbon atoms at most, or 2 carbon atoms at most, or any value and range therebetween. Each possibility represents a separate embodiment of the invention.

In some embodiments, the alkyl chain is covalently bound to PEI. In some embodiments, the alkyl chain is covalently bound to PEI via a C—N bond. In some embodiments, the alkyl chain is covalently bound to PEI via an amide bond. In some embodiments, the alkyl chain is covalently bound to a nitrogen atom of PEI. In some embodiments, the alkyl chain is covalently bound to an amino group of PEI. In some embodiments, the alkyl chain is covalently bound to an amino group of PEI, wherein the amino group comprises a primary amine, a secondary amine, a tertiary amine or a combination thereof. In some embodiments, the alkyl chain is covalently bound to a primary amine, a secondary amine or both. In some embodiments, the alkyl chain comprises a hydroxy substituent.

In some embodiments, at least a portion of the amines within the PEI are substituted (or covalently bound) to the alkyl chain, wherein the alkyl chain is as described herein.

In some embodiments, at least 5%, at least 10%, at least 15%, at least 20%, at least 30%, at least 50%, at least 70%, at least 90%, at least 95% including any range therebetween, of amino groups are alkyl substituted, wherein the amino groups comprise a primary amine, a secondary amine, a tertiary amine or a combination thereof.

In some embodiments, the alkylated PEI is synthesized by reacting a non-substituted (or pristine) PEI with an alkyl bearing a reactive group, wherein the reactive group is capable of undergoing a reaction (such as a nucleophilic addition or a nucleophilic substitution reaction) with an amino group of PEI. In some embodiments, the reactive group comprises any of epoxy, halo, carboxy, ester, an activated ester (such as NHS-ester) or any combination thereof. Other reactive groups capable of reacting with an amino group of PEI so as to form a stable covalent bond are well known in the art.

As used herein, “alkyl” or “alkylated” refers to a radical of a straight-chain or branched saturated hydrocarbon group having from 1 to 14 carbon atoms (“C1-14 alkyl”). In some embodiments, “alkyl” or “alkylated” refers to a radical of a straight-chain or branched saturated hydrocarbon group having from 1 to 28 carbon atoms (“C1-28 alkyl”). In some embodiments, an alkyl group has C5-26 alkyl, C6-27 alkyl, C7-19 alkyl, C8-24 alkyl, C9-22 alkyl, C10-26 alkyl, C11-27 alkyl, C12-26 alkyl, C13-25 alkyl, C14-23 alkyl, C15-20 alkyl, C1-23 alkyl, C1-21 alkyl, C1-19 alkyl, C1-17 alkyl, C1-16 alkyl, C1-15 alkyl, C1-13 alkyl, C1-9 alkyl, C1-8 alkyl, C1-7 alkyl, C1-6 alkyl, C1-5 alkyl, C1-4 alkyl, C1-3 alkyl, or C1-2 alkyl. Each possibility represents a separate embodiment of the invention.

In some embodiments, the alkyl chain consists of 14 carbon atoms. In some embodiments, the nanoparticle comprises an alkyl chain consisting of 14 carbons.

In some embodiments, a molar ratio between alkylated amines and non-alkylated amines within the alkylated PEI is between 100:1 to 1:3, between 100:1 to 90:1, between 90:1 to 80:1, between 80:1 to 70:1, between 70:1 to 60:1, between 60:1 to 40:1, between 40:1 to 20:1, between 20:1 to 10:1, between 10:1 to 5:1, between 5:1 to 3:1, between 3:1 to 1:1, between 1:1 to 1:3, between 1:1 to 1:2, between 1:2 to 1:3, including any value therebetween.

In some embodiments, a molar ratio between the alkyl chain and a non-modified PEI within the alkylated PEI is between 50:1 and 1:10, between 50:1 and 40:1, between 40:1 and 30:1, between 30:1 and 20:1, between 20:1 and 15:1, between 15:1 and 10:1, between 10:1 and 8:1, between 8:1 and 5:1, between 5:1 and 4:1, between 4:1 and 3:1, between 3:1 and 2:1, between 2:1 and 1:1, between 1:1 and 1:2, between 1:2 and 1:3, between 1:3 and 1:4, between 1:4 and 1:5, between 1:5 and 1:7, between 1:7 and 1:10, including any value therebetween.

In some embodiments, the nanoparticles comprises nitrogen to phosphate (N:P) molar ratio ranging from 1:1 to 9:1, 1:1 to 8:1, 1:1 to 7:1, 1:1 to 6:1, 1:1 to 5:1, 1:1 to 4:1, 1:1 to 3:1, 1:1 to 2:1, 1:1 to 15:1, 1:1 to 13:1, 1:1 to 12:1, or 1:1 to 10:1. Each possibility represents a separate embodiment of the invention.

In some embodiments, the nanoparticle of the invention is devoid of a sterol. In some embodiments, the nanoparticle of the invention does not comprise a sterol. In some embodiments, a sterol is or comprises cholesterol.

In some embodiments, the nanoparticle has a particle size between 100 nm and 500 nm, 150 nm and 500 nm, 200 nm and 475 nm, 150 nm and 350 nm, 175 nm and 400 nm, or 200 nm and 390 nm. Each possibility represents a separate embodiment of the invention.

In some embodiments, the nanoparticle has a particle size between 100 nm and 300 nm.

In some embodiments, the nanoparticle has a particle size of at least 100 nm, at least 150 nm, at least 200 nm, at least 250 nm, at least 300 nm, at least 350 nm, at least 400 nm, at least 450 nm, at least 475 nm, or at least 500 nm. Each possibility represents a separate embodiment of the invention.

In some embodiments, the nanoparticle has a particle size of 100 nm at most, 150 nm at most, 200 nm at most, 250 nm at most, 300 nm at most, 350 nm at most, 400 nm at most, 450 nm at most, 475 nm at most, or 500 nm at most. Each possibility represents a separate embodiment of the invention.

In some embodiments, “particle size” comprises a diameter of the particle. In some embodiments, a diameter comprises an average diameter of a population of nanoparticles.

In some embodiments, the nanoparticle is a polycationic nanoparticle.

In some embodiments, the nanoparticle comprises a single lamella. In some embodiments, the particle comprises a plurality of lamellae. In some embodiments, the nanoparticle is a unilamellar or a multilamellar nanoparticle.

In some embodiments, the polynucleotide is bound to the nanoparticle. In some embodiments, the polynucleotide is bound to a plurality of lamellae of the multilamellar nanoparticle. In some embodiments, a polynucleotide is bound to at least 2 lamellae of a multilamellar nanoparticle. In some embodiments, bound is via an electrostatic interaction. In some embodiments, bond is electrostatically bound.

In some embodiments, the polynucleotide is bound to a plurality of lamellae so as to form a plurality of inner domains within the particle. In some embodiments, the plurality of lamellae are bound to the polynucleotide so that a distance between the adjacent lamellae ranges from 1 to 20 nm, from 1 to 5 nm, from 5 to 7 nm, from 7 to 9 nm, from 9 to 15 nm, from 15 to 20 nm, or any value and range therebetween. Each possibility represents a separate embodiment of the invention.

In some embodiments, the polynucleotide is bound to a plurality of lamellae so as to form a polyplex, wherein the polyplex is as described herein. In some embodiments, the distance between the adjacent inner domains (or polyplexes) within the particle ranges from 1 to 20 nm, from 1 to 5 nm, from 5 to 7 nm, from 7 to 9 nm, from 9 to 15 nm, from 15 to 20 nm, or any value and range therebetween. Each possibility represents a separate embodiment of the invention.

In some embodiments, the polynucleotide is layered on top or in between lipids of the nanoparticle. In some embodiments, the polynucleotide is covered or wrapped by lipids of the nanoparticle. In some embodiments, the lipids of the nanoparticle cover or wrap the polynucleotide in a spiral shape.

In some embodiments, the distance between the adjacent inner domains (or polyplexes) within the particle is between 5 and 9 nm including any range therebetween.

In some embodiments, the polynucleotide comprises 60 to 500 nucleobases, 60 to 450 nucleobases, 60 to 400 nucleobases, 60 to 350 nucleobases, 60 to 250 nucleobases, 90 to 500 nucleobases, 90 to 375 nucleobases, 100 to 500 nucleobases, 100 to 350 nucleobases, or 150 to 450 nucleobases. Each possibility represents a separate embodiment of the invention.

In some embodiments, the polynucleotide comprises or consists of 100 to 350 nucleobases.

In some embodiments, the polynucleotide comprises at least 60 nucleobases, at least 100 nucleobases, at least 200 nucleobases, at least 250 nucleobases, at least 300 nucleobases, at least 350 nucleobases, at least 400 nucleobases, at least 450 nucleobases, at least 475 nucleobases, or at least 500 nucleobases. Each possibility represents a separate embodiment of the invention.

In some embodiments, the polynucleotide comprises 70 nucleobases at most, 100 nucleobases at most, 200 nucleobases at most, 250 nucleobases at most, 300 nucleobases at most, 375 nucleobases at most, 425 nucleobases at most, 475 nucleobases at most, 500 nucleobases at most, 750 nucleobases at most, 1,000 nucleobases at most, 1,250 nucleobases at most, 1,750 nucleobases at most, or 2,500 nucleobases at most. Each possibility represents a separate embodiment of the invention.

In some embodiments, the polynucleotide comprises a plurality of polynucleotide types. In some embodiments, the nanoparticle comprises a plurality of polynucleotide types. In some embodiments, the composition comprises a plurality of nanoparticle types, each type of nanoparticle comprises a specific polynucleotide.

In some embodiments, a specific polynucleotide comprises a plurality of polynucleotide molecules harboring the same or an identical nucleic acid sequence. In some embodiments, a specific polynucleotide comprises a plurality of polynucleotide molecules harboring essentially the same nucleic acid sequence.

As used herein, the term “plurality” encompasses any integer equal to or greater than 2. In some embodiments, a plurality comprises at least 2, at least 3, at least 4, at least 5, at least 6, at least 7, at least 8, at least 9, or at least 10, or any value and range therebetween. Each possibility represents a separate embodiment of the invention.

As used herein, the term “polynucleotide types” refers to a plurality of polynucleotides each of which comprises a nucleic acid sequence differing from any one of the other polynucleotides of the plurality of polynucleotides by at least 1 nucleobase, at least 1 nucleobase, at least 1 nucleobase, at least 1 nucleobase, at least 1 nucleobase, or at least 10 nucleobases, or any value and range therebetween. Each possibility represents a separate embodiment of the invention.

In some embodiments, a polynucleotide comprises RNA, DNA, a synthetic analog of RNA, a synthetic analog of DNA, DNA/RNA hybrid, or any combination thereof. In some embodiments, a nanoparticle of the invention comprises a polynucleotide selected from: RNA, DNA, a synthetic analog of RNA, a synthetic analog of DNA, DNA/RNA hybrid, or any combination thereof.

In some embodiments, the polynucleotide comprises or consists of RNA.

In some embodiments, the polynucleotide comprises an inhibitory nucleic acid. In some embodiments, the polynucleotide comprises an antisense oligonucleotide.

As used herein, an “antisense oligonucleotide” refers to a nucleic acid sequence that is reversed and complementary to a DNA or RNA sequence.

As referred to herein, a “reversed and complementary nucleic acid sequence” is a nucleic acid sequence capable of hybridizing with another nucleic acid sequence comprised of complementary nucleotide bases. By “hybridize” is meant pair to form a double-stranded molecule between complementary nucleotide bases (e.g., adenine (A) forms a base pair with thymine (T) (or uracil (U) in the case of RNA), and guanine (G) forms a base pair with cytosine (C)) under suitable conditions of stringency. (See, e.g., Wahl, G. M. and S. L. Berger (1987) Methods Enzymol. 152:399; Kimmel, A. R. (1987) Methods Enzymol. 152:507). For the purposes of the present methods, the inhibitory nucleic acid need not be complementary to the entire sequence, only enough of it to provide specific inhibition; for example, in some embodiments the sequence is 100% complementary to at least nucleotides (nts) 2-7 or 2-8 at the 5′ end of the microRNA itself (e.g., the ‘seed sequence’), e.g., nts 2-7 or 20.

In some embodiments of the inhibitory nucleic acid has one or more chemical modifications to the backbone or side chains. In some embodiments, the inhibitory nucleic acid has at least one locked nucleotide, and/or has a phosphorothioate backbone.

Non-limiting examples of inhibitory nucleic acids useful according to the herein disclosed invention include, but are not limited to: antisense oligonucleotides, ribozymes, external guide sequence (EGS) oligonucleotides, siRNA compounds, single- or double-stranded RNA interference (RNAi) compounds such as siRNA compounds, modified bases/locked nucleic acids (LNAs), antagomirs, peptide nucleic acids (PNAs), and other oligomeric compounds or oligonucleotide mimetics which hybridize to at least a portion of the target nucleic acid and modulate its function. In some embodiments, the inhibitory nucleic acids include antisense RNA, antisense DNA, chimeric antisense oligonucleotides, antisense oligonucleotides comprising modified linkages, interference RNA (RNAi), short interfering RNA (siRNA); a micro, interfering RNA (miRNA); a small, temporal RNA (stRNA); or a short, hairpin RNA (shRNA); small RNA-induced gene activation (RNAa); small activating RNAs (saRNAs), or combinations thereof.

In some embodiments, the inhibitory nucleic acid is an RNA interfering molecule (RNAi). In some embodiments, the RNAi is or comprises double stranded RNA (dsRNA).

As used herein “an interfering RNA” refers to any double stranded or single stranded RNA sequence, capable—either directly or indirectly (i.e., upon conversion)—of inhibiting or down regulating gene expression by mediating RNA interference. Interfering RNA includes but is not limited to small interfering RNA (“siRNA”) and small hairpin RNA (“shRNA”). “RNA interference” refers to the selective degradation of a sequence-compatible messenger RNA transcript.

In some embodiments, the polynucleotide is chemically modified. In some embodiments, the chemical modification is a modification of a backbone of the polynucleotide. In some embodiments, the chemical modification is a modification of a sugar of the polynucleotide. In some embodiments, the chemical modification is a modification of a nucleobase of the polynucleotide. In some embodiments, the chemical modification increases stability of the polynucleotide in a cell. In some embodiments, the chemical modification increases stability of the polynucleotide in vivo. In some embodiments, the chemical modification increases the stability of the polynucleotide in vitro, such as, in the open air, field, on a surface exposed to air, etc. In some embodiments, the chemical modification increases the polynucleotide's ability to induce silencing of a target gene or sequence, including, but not limited to an RNA molecule derived from a pathogen or an RNA derived from a plant cell, as described herein. In some embodiments, the chemical modification is selected from: a phosphate-ribose backbone, a phosphate-deoxyribose backbone, a phosphorothioate-deoxyribose backbone, a 2′-O-methyl-phosphorothioate backbone, a phosphorodiamidate morpholino backbone, a peptide nucleic acid backbone, a 2-methoxyethyl phosphorothioate backbone, a constrained ethyl backbone, an alternating locked nucleic acid backbone, a phosphorothioate backbone, N3′-P5′ phosphoroamidates, 2′-deoxy-2′-fluoro-β-d-arabino nucleic acid, cyclohexene nucleic acid backbone nucleic acid, tricyclo-DNA (tcDNA) nucleic acid backbone, ligand-conjugated antisense, and a combination thereof.

In some embodiments, the RNA comprises at least 70% complementarity, at least 80% complementarity, at least 90% complementarity, at least 95% complementarity, at least 97% complementarity, at least 99% complementarity, or is 100% complementary to at least one RNA molecule derived from a pathogen, or any value and range therebetween. Each possibility presents a separate embodiment of the invention. In some embodiments, the RNA comprises 70-95% complementarity, 80-100% complementarity, or 75-99% complementarity to at least one RNA molecule derived from a pathogen. Each possibility presents a separate embodiment of the invention.

In some embodiments, the RNA is complementary to any location along a target sequence. In some embodiments, the RNA is complementary to a 3′ end of a target sequence. In some embodiments, the RNA is complementary to a sequence within the 3′ untranslated region of a target sequence. In some embodiments, the target sequence is a gene or a transcript thereof. In some embodiments, a transcript comprises a pre-mRNA, a mature mRNA, an alternatively spliced mRNA, or any combination thereof.

In some embodiments, the RNA comprises at least 70% complementarity, at least 80% complementarity, at least 90% complementarity, at least 95% complementarity, at least 97% complementarity, at least 99% complementarity, or is 100% complementary to at least one at least one RNA molecule derived from a plant cell, or any value and range therebetween. Each possibility presents a separate embodiment of the invention. In some embodiments, the RNA comprises 70-95% complementarity, 80-100% complementarity, or 75-99% complementarity to at least one at least one RNA molecule derived from a plant cell. Each possibility presents a separate embodiment of the invention.

In some embodiments, the nanoparticle comprises or is a polyplex. In some embodiments, the polyplex comprises a polynucleotide in contact with or bound to the amphiphilic copolymer. In some embodiments, the polynucleotide is bound to the amphiphilic copolymer via a non-covalent bond. In some embodiments, the polynucleotide is bound to the amphiphilic copolymer via an electrostatic interaction.

In some embodiments, the nanoparticle of the invention further comprises a biologically active agent.

As used herein, the term “biologically active agent” refers to any compound capable of eliciting a direct physiological response in a cell or an organism.

In some embodiments, a biologically active agent is an antibiotic compound. In some embodiments, a biologically active agent is anti-fungal compound.

In some embodiments, a w/w ratio of the biologically active agent within the nanoparticle is between 0.1 and 20%, between 0.1 and 1%, between 1 and 5%, between 5 and 10%, or between 10 and 20%, including any range between. Each possibility represents a separate embodiment of the invention. In some embodiments, a w/w ratio of the biologically active agent and the polynucleotide within the nanoparticle is between 0.1 and 20%, between 0.1 and 1%, between 1 and 5%, between 5 and 10%, or between 10 and 20%, including any range between. Each possibility represents a separate embodiment of the invention.

### Compositions

According to some embodiments, there is provided a composition comprising the nanoparticle of the invention, and an agriculturally acceptable carrier. In some embodiments, the composition of the invention comprises a plurality of nanoparticles.

In some embodiments, the composition of the invention comprises a plurality of nanoparticles of the invention and an agriculturally acceptable carrier.

In some embodiments, there is provided an agricultural composition comprising the nanoparticle of the invention and an acceptable carrier. In some embodiments, there is provided an agricultural composition comprising an agriculturally effective amount of the nanoparticles of the invention. In some embodiments, there is provided an agricultural composition comprising an agriculturally effective amount of the polynucleotide of the invention. In some embodiments, agriculturally effective amount comprises therapeutically effective amount. In some embodiments, therapeutically effective amount is directed to an agricultured organism or crop. In some embodiments, the sensitive organism or crop comprises a plant.

In some embodiments, the carrier is an agriculturally acceptable carrier. In some embodiments, an agriculturally acceptable carrier comprises an environmentally acceptable carrier. Such carriers can be any material that an animal, a plant or the environment to be treated can tolerate. In some embodiments, the carrier comprises any material, which can be added to the particle of the invention, or a composition comprising same, without causing or having an adverse effect on the environment, or any species or an organism other than the pathogen. Furthermore, the carrier must be such that the nanoparticle or composition comprising same, remains effective for introducing a polynucleotide to a plant and/or preventing or treating a viral infectious disease in a plant.

In some embodiments, the agriculturally acceptable carrier is selected from a group of: a solvent, a surfactant, a dispersant, a sticking agent, a spreading agent, a synergist, a penetrant, a compatibility agent, a buffer, a defoaming agent, a thickener, a drift retardant, or any combination thereof.

In some embodiments, the agriculturally acceptable carrier is or comprises a surfactant.

In some embodiments, the w/w concentration of the agriculturally acceptable carrier within the composition is between 0.1 and 99%, between 0.1 and 1%, between 1 and 10%, between 10 and 20%, between 20 and 30%, between 30 and 50%, between 50 and 60%, between 60 and 80%, or between 80 and 90%, including any range between. Each possibility represents a separate embodiment of the invention.

In some embodiments, the carrier is a liquid carrier. In some embodiments, the carrier is configured to spraying and/or aerosol applications.

In some embodiments, any one of the nanoparticles of the invention, or a composition comprising same is characterized by having a mean Zeta potential ranging from 1 mV to 10 mV, 1 mV to 20 mV, 1 mV to 30 mV, 1 mV to 40 mV, 5 mV to 25 mV, or 5 mV to 35 mV. Each possibility represents a separate embodiment of the invention.

In some embodiments, the plurality of nanoparticles of the invention is characterized by a polydispersity index (PDI) between 1 and 1.5, including any value and range therebetween. In some embodiments, at least 60%, at least 70%, at least 80%, or at least 90% of the plurality of nanoparticles within the composition of the invention is devoid of particles having a particle size of less than 100 nm, or any value and range therebetween. Each possibility represents a separate embodiment of the invention. In some embodiments, at least 60%, at least 70%, at least 80%, or at least 90% of the plurality of nanoparticles is devoid of particles having a particle size of greater than 500 nm, or any value and range therebetween. Each possibility represents a separate embodiment of the invention.

In some embodiments, the composition is formulated for administration by spraying. In some embodiments, the composition is formulated for administration as a spray or an aerosol. In some embodiments, the composition is formulated for administration by spraying, drenching, dipping, soaking, or injecting.

### Methods of Use

According to some embodiments, there is provided a method for introducing a polynucleotide to a plant.

In some embodiments, the method utilizes a nanoparticle as disclosed herein, or a composition comprising same.

### Pest Control

Agricultural pests cause major yield and economic losses worldwide. Pests can develop resistance to chemical pesticides and breeding strategies faster than can be engineered for, hence there is an urgent need for alternatives in pest management strategies.

Development of RNAi biopesticides delivered by a nanoparticle carrier, which in turn is up-taken and delivered to the pest by the plant, could give an alternative to broad-spectrum chemical-based control measures for pests and pathogens, which would instead be targeted accurately and specifically with minimal off-target effects. Rapidly changing pathogens such as fungi, bacteria, and viruses, could be quickly characterized, sequenced, and included in an RNAi biopesticide—a clear advantage over standard pest control practices today which take a few years to breed resistance or engineer chemical protections for.

According to some embodiments, the herein disclosed nanoparticle and method of using same, are directed to pathogen or pest control. In some embodiments, the pathogen is a plant pathogen. According to some embodiments, there is provided a method for preventing or treating a viral infectious disease in a plant.

Non-limiting examples of pests include but are not limited to, insects, mites, ticks (and other arthropods), mice, rats, and other rodents, slugs, snails, nematodes, cestodes (and other parasites), weeds, fungi, bacteria, viruses and other pathogens.

In some embodiments, the pathogen is selected from: a virus, a bacterium, a fungus, a protozoan (such as but not limited to zoosporic protozoa), a nematode, or an arthropod.

As used herein, the term “pathogen” and “pest” are interchangeable.

In some embodiments, the pathogen is a virus. In some embodiments, the pathogen is an arthropod. In some embodiments, the pathogen is a nematode. In some embodiments, the pathogen is a protozoan. In some embodiments, the virus is transmitted via any one of: arthropod, a nematode, a protozoan.

In some embodiments, the arthropod comprises an insect or an arachnid, including any developmental stage thereof, e.g., larvae, nymph, etc.

In some embodiments, the virus comprises a virus being transmitted by the obscure or tubber mealybug (e.g., Pseudococcus viburni)

Plant pathogens and/or pest are common and would be apparent to one of ordinary skill in the art.

In some embodiments, the virus comprises a genome comprising DNA, RNA, or a hybrid thereof. In some embodiments, the virus comprises a single stranded genome (e.g., the genomic matter, is made of a single stranded nucleic acid molecule). In some embodiments, the virus comprises a double stranded genome (e.g., the genomic matter, is made of two antiparallel nucleic acid molecules hybridized to one another).

In some embodiments, the virus belongs to the genus Ampelovirus.

### Plant Metabolic Control

Postharvest handling and control of fruit have become critical in reducing supply chain waste, increasing fruit quality, farming profitability, and overall fruit availability during any given time. The technology of RNAi targeting via a nanoparticle carrier can be used for the metabolic control of plant genes in order to improve the value of agricultural food crops.

According to some embodiments, the herein disclosed nanoparticle and method of using same, are directed to plant metabolic control.

One example of the issues in the postharvest arena is banana browning, which occurs due to chilling injury and physical stress and is responsible for a significant decrease in its commercial value. Browning occurs mainly due to increased production of the polyphenol oxidase (PPO) and phenylalanine ammonia-lyase (PAL) enzymes. RNAi induced silencing of the genes responsible for PPO and PAL enzymes could ensure a safety net of sorts throughout the supply chain. In one embodiment, the nanoparticle of the invention comprises an RNA polynucleotide comprising at least 70% complementarity to an RNA molecule encoding PPO, PAL, or a combination thereof, derived from a plant cell. Another area of interest in postharvest control of fruit is in tomato ripening and storage fitness. Lycopene has been shown to rapidly accumulate with a significant correlation to red color values and tomato firmness. Lycopene is produced from terpenoid precursors and is constantly broken down into β-carotene by lycopene cyclase. Before ripening, lycopene cyclase inhibits lycopene accumulation, hence the tomato stays green. As lycopene cyclase is suppressed during ripening, the tomato turns redder and softer. Thus, RNAi induced silencing of lycopene cyclase could affect the accumulation of lycopene and trigger the ripening of tomatoes. In one embodiment, the nanoparticle of the invention comprises an RNA polynucleotide comprising at least 70% complementarity to an RNA molecule encoding lycopene cyclase derived from a plant cell.

RNAi technology can also influence plant metabolism during its agricultural growth cycle. Using RNAi to effectively target genomes and change the resulting phenotype without genetically modifying the plant is a strategy with limitless potential to combat increasingly important issues such as climate change, market demand, or regulatory barriers. One such example of actively silencing plant genes is to directly reduce the activity of certain genes responsible for certain unwanted metabolite production and accumulation in crops. For instance, tetrahydrocannabinol (THC) accumulation in the cultivation of cannabis as “hemp” is an unwanted byproduct in scenarios where the crop is grown for the purposes of alternative cannabinoids, fiber, grain, or aromatic terpenes. Selective RNAi silencing of cannabinoid synthases such as tetrahydrocannabinolic acid synthase (THCAS) and cannabichromenic acid synthase (CBCAS), or even silencing of enzymes responsible for overall cannabinoid production such as aromatic prenyltransferases (PT) producing cannabigerol (CBG), can lead to the growth of lower THC or cannabinoid-free hemp which can stay compliant within strict regulatory cultivation guidelines and be used for alternative and more efficient production of terpenes, fiber, grain, and minor cannabinoids. In one embodiment, the nanoparticle of the invention comprises an RNA polynucleotide comprising at least 70% complementarity to an RNA molecule encoding THCAS, CBCAS, PT, or any combination thereof, derived from a plant cell. In one embodiment, the nanoparticle of the invention comprises an RNA polynucleotide comprising at least 70% complementarity to an RNA molecule encoding a cannabinoidogenesis related gene derived from a plant cell. Another example targets the use of RNAi technology not to directly silence plant genes creating certain compounds, but rather to silence side-reactions inside of biosynthetic pathways in order to actively redirect carbon flux and “upregulate” other pathways. For instance, Patatin is a potato tuber protein which is facing increased demand worldwide due to its use as a non-animal-based food texturizer and coagulator in alternative meat solutions. RNAi silencing of targets such as acetyl-CoA-carboxylase or ketoacyl ACP synthase, involved in reactions producing side products like lipids, can potentially cause an upregulated carbon flux towards wanted gene targets and enzymes such as PEPC, driving metabolic accumulation of favored products and resulting in increased Patatin or other protein content by weight. Such solutions are critical in taking advantage of current production capacity of commodities and allowing for more efficient production of desirable products. In one embodiment, the nanoparticle of the invention comprises an RNA polynucleotide comprising at least 70% complementarity to an RNA molecule encoding an acetyl-CoA-carboxylase, ketoacyl ACP synthase, or a combination thereof, derived from a plant cell.

In some embodiments, the method comprises contacting a plant or a part thereof with a therapeutically effective amount of: the nanoparticle of the invention or a composition comprising same, as described herein.

In some embodiments, a polynucleotide introduced into a plant or a part thereof is introduced into at least one cell of the plant. In some embodiments, a polynucleotide introduced into at least one cell of the plant is capable of inducing or activating an RNA expression modifying enzyme or complex in the at least one cell. In some embodiments, RNA expression modifying enzyme or complex comprises an RNA-induced silencing complex (RISC) or any functional analog thereof.

In some embodiments, a polynucleotide introduced into a plant or a part thereof is capable of inducing the silencing of a plant endogenous gene. Polynucleotide introduced into a plant or a part thereof is capable of inducing the silencing and/or degradation of an RNA molecule derived from a pathogen infecting, residing within the plant (e.g., at least one cell of the plant), feeding of the plant, or any combination thereof.

As used herein, the term “RISC analog” refers to any peptide or protein capable of inhibiting RNA translation, reducing RNA stability, increasing RNA degradation, in response to the presence of an exogenous RNA (inclusive of double stranded RNA comprising a nucleic acid sequence of an endogenous gene or sequence).

In some embodiments, a viral infectious disease comprises grapevine leafroll disease (GLD).

In some embodiments, the viral infectious disease is induced by or involves a virus listed under Table 1 herein below.

TABLE 1
List of known plant viruses

| Order | Family | Genus | Species |
|---|---|---|---|
| Serpentovirales | Aspiviridae | Ophiovirus | Citrus psorosis ophiovirus |
| | | | Citrus sp. |
| Serpentovirales | Aspiviridae | Ophiovirus | Mirafiori lettuce big-vein |
| | | | ophiovirus |
| | | | Lactuca sativa |
| Mononegavirales | Rhabdoviridae | Cytorhabdovirus | Strawberry crinkle |
| | | | cytorhabdovirus |
| | | | Fragaria × ananassa |
| Mononegavirales | Rhabdoviridae | Cytorhabdovirus | Maize chlorotic vein banding |
| | | unclassif. | virus |
| | | | Zea mays |
| | | | Soursop yellow blotch virus |
| | | | Anonna muricata |
| Mononegavirales | Rhabdoviridae | Cytorhabdovirus | Cytorhabdovirus (unidentified) |
| | | unclassif. | |
| | | | Arracacia xanthorhiza |
| | | | Beta vulgaris L. var. cicla |
| | | | Callistephus chinensis |
| | | | Orchid (Laelia sp.) |
| | | | Phaseolus vulgaris |
| | | | Pisum sativum |
| | | | Pogostemum patchouly |
| | | | Tapeinochilus ananassae |
| | | | Triticum aestivum |
| Mononegavirales | Rhabdoviridae | Dichorhavirus | Citrus chlorotic spot |
| | | | dichorhavirus |
| | | | Citrus sp. |
| Mononegavirales | Rhabdoviridae | Dichorhavirus | Citrus leprosis N dichorhavirus |
| | | | Citrus sp. |
| Mononegavirales | Rhabdoviridae | Dichorhavirus | Clerodendrum chlorotic spot |
| | | | dichorhavirus |
| | | | Anonna muricata |
| | | | Clerodendrum × speciosum |
| | | | C. thomsonae, C. splendens |
| | | | Hibiscus rosa-sinensis |
| | | | Malvaviscus arboreus |
| | | | Spathiphyllum wallisii |
| Mononegavirales | Rhabdoviridae | Dichorhavirus | Coffee ringspot dichorhavirus |
| | | | Coffea arabica |
| | | | Coffea spp. |
| | | | Psilanthus ebracteolatus |
| | | | Spathiphyllum wallisii |
| Mononegavirales | Rhabdoviridae | Dichorhavirus | Orchid fleck dichorhavirus |
| | | | Orchids (several genera and |
| | | | species) |
| Mononegavirales | Rhabdoviridae | Dichorhavirus | Dichoravirus unidentified |
| | | unclassif. | |
| | | | Allamanda cathartica |
| | | | Bidens pilosa |
| | | | Cestrum nocturnum |
| | | | Gardenia jasminoides |
| | | | Monstera deliciosa |
| | | | Mussaenda erythrophylla |
| | | | Piper callosum |
| | | | Piper nigrum |
| | | | Ruellia chartacea |
| | | | Solanum violaefolium |
| Mononegavirales | Rhabdoviridae | Nucleorhabdovirus | Eggplant mottled dwarf |
| | | | nucleorhabdovirus |
| | | | Hibiscus rosa-sinensis |
| Mononegavirales | Rhabdoviridae | Nucleorhabdovirus | Sonchus yellow net |
| | | | nucleorhabdovirus |
| | | | Kalanchoe blossfeldiana |
| Mononegavirales | Rhabdoviridae | Nucleorhabdovirus | Sowthistle yellow vein |
| | | | nucleorhabdovirus |
| | | | Bidens pilosa |
| | | | Cotyledon orbiculata |
| Mononegavirales | Rhabdoviridae | Nucleorhabdovirus | Gomphrena virus |
| | | unclassif. | |
| | | | Gomphrena globosa |
| | | | Joa yellow blotch virus |
| | | | Solanum aculeatissimum |
| Mononegavirales | Rhabdoviridae | Nucleorhabdovirus | Nucleorhabdovirus (unidentified) |
| | | unclassif. | |
| | | | Ananas comosus |
| | | | Carica papaya |
| | | | Chrysanthemum morifolium |
| | | | Clerodendrum × speciosum |
| | | | Coreopsis lanceolata |
| | | | Cosmos sulphureus |
| | | | Cucurbita moschata × C. maxima |
| | | | Lactuca sativa |
| | | | Manihot esculenta |
| | | | Passiflora edulis |
| | | | Pogostemum patchouly |
| | | | Porophyllum ruderale |
| | | | Raphanus sp. |
| Mononegavirales | Rhabdoviridae | Varicosavirus | Lettuce big-vein associated |
| | | | varicosavirus |
| | | | Lactuca sativa |
| | | | Sonchus oleraceus |
| Bunyavirales | Fimoviridae | Emaravirus | Fig mosaic emaravirus |
| | | | Ficus carica |
| Bunyavirales | Phenuiviridae | Tenuivirus putative | Wheat white spike virus |
| | | | Triticum aestivum |
| Bunyavirales | Tospoviridae | Orthotospovirus | Bean necrotic mosaic |
| | | | orthotospovirus |
| | | | Phaseolus vulgaris |
| Bunyavirales | Tospoviridae | Orthotospovirus | Chrysanthemum stem necrosis |
| | | | orthotospovirus |
| | | | Alstroemeria sp. |
| | | | Bouvardia sp |
| | | | Callistephus chinensis |
| | | | Chrysanthemum morifolium |
| | | | Eustoma grandiflorum |
| | | | Gerbera jamesonii |
| | | | Senecio douglasii |
| | | | Sinningia speciosa |
| | | | Solanum lycopersicum |
| Bunyavirales | Tospoviridae | Orthotospovirus | Groundnut ringspot tospovirus |
| | | | Arachis hypogaea |
| | | | Boerhavia coccinea |
| | | | Caesalpinia echinata |
| | | | Callistephus chinensis |
| | | | Capsicum annuum |
| | | | Capsicum baccatum |
| | | | Citrullus lanatus |
| | | | Coriandrum sativum |
| | | | Cucumis sativus |
| | | | Eustoma grandiflorum |
| | | | Guibourtia hymenifolia |
| | | | Hippeastrum sp. |
| | | | Lactuca sativa |
| | | | Nicotiana tabacum |
| | | | Solanum lycopersicum |
| | | | Solanum melongena |
| | | | Solanum sessiliflorum |
| Bunyavirales | Tospoviridae | Orthotospovirus | Iris yellow spot tospovirus |
| | | | Allium cepa |
| Bunyavirales | Tospoviridae | Orthotospovirus | Tomato chlorotic spot tospovirus |
| | | | Bouvardia sp |
| | | | Caesalpinia echinata |
| | | | Callistephus chinensis |
| | | | Capsicum annuum |
| | | | Capsicum baccatum |
| | | | Cichorium endivia |
| | | | Dieffenbachia spp |
| | | | Eryngium phoetidum |
| | | | Gerbera jamesonii |
| | | | Lactuca sativa |
| | | | Mirabilis jalapa |
| | | | Nicotiana tabacum |
| | | | Physalis peruviana |
| | | | Solanum aethiopicum |
| | | | Solanum lycopersicum |
| | | | Solanum sessiliflorum |
| | | | Spylanthes oleracea |
| Bunyavirales | Tospoviridae | Orthotospovirus | Tomato spotted wilt tospovirus |
| | | | Alstroemeria sp. |
| | | | Arachis hypogaea |
| | | | Bouvardia sp |
| | | | Caesalpinia echinata |
| | | | Campanula medium |
| | | | Capsicum annuum |
| | | | Capsicum baccatum |
| | | | Capsicum chinense |
| | | | Capsicum frutescens |
| | | | Cicer arietinum |
| | | | Dieffenbachia spp |
| | | | Emilia sagittata |
| | | | Eucharis grandiflora |
| | | | Eustoma grandiflorum |
| | | | Lactuca sativa |
| | | | Lens culinaria |
| | | | Nicotiana tabacum |
| | | | Pisum sativum |
| | | | Senecio douglasii |
| | | | Sinningia speciosa |
| | | | Solanum lycopersicum |
| | | | Solanum melongena |
| | | | Solanum tuberosum |
| Bunyavirales | Tospoviridae | Orthotospovirus | Zucchini lethal chlorosis |
| | | | tospovirus |
| | | | Citrullus lanatus |
| | | | Cucumis anguria |
| | | | Cucumis melo |
| | | | Cucumis sativus |
| | | | Cucurbita moschata |
| | | | Cucurbita pepo var. Caserta |
| Bunyavirales | Tospoviridae | Orthotospovirus | Tospovirus (unidentified) |
| | | putative | |
| | | | Amaranthus sp. |
| | | | Bidens pilosa |
| | | | Capsicum annuum |
| | | | Chrysanthemum leucanthemum |
| | | | Chrysanthemum morifolium |
| | | | Cichorium intybus |
| | | | Commelina spp., |
| | | | Dahlia variabilis |
| | | | Glycine max |
| | | | Gnaphalium spicatum |
| | | | Orchid (Oncidium sp.) |
| | | | Petunia × hybrida |
| | | | Portulaca oleracea |
| | | | Sesamum indicum |
| | | | 29ensiti. |
| | | | Solanum mammosum |
| | | | Spylanthes oleracea |
| | | | Tropaeolum majus |
| Picornavirales | Secoviridae | Comovirus | Andean potato mottle virus |
| | | | Solanum aethiopicum |
| | | | Solanum melongena |
| | | | Solanum sisymbriifolium |
| | | | Solanum tuberosum |
| Picornavirales | Secoviridae | Comovirus | Bean rugose mosaic virus |
| | | | Glycine max |
| | | | Phaseolus vulgaris |
| Picornavirales | Secoviridae | Comovirus | Cowpea severe mosaic virus |
| | | | Calopogonium mucunoides |
| | | | Canavalia ensiformes |
| | | | Centrosema pubescens |
| | | | Crotalaria juncea |
| | | | Crotalaria paulinea |
| | | | Glycine max |
| | | | Macroptilium lathyroides |
| | | | Phaseolus lunatus |
| | | | Phaseolus vulgaris |
| | | | Psophocarpus tetragonolobus |
| | | | Pueraria sp. |
| | | | Vigna luteola |
| | | | Vigna mungo |
| | | | Vigna radiata |
| | | | Vigna unguiculata |
| | | | Vigna |
| | | | unguiculata Subsp. Sesquipedalis |
| | | | Vigna vexillata |
| Picornavirales | Secoviridae | Comovirus | Squash mosaic virus |
| | | | Citrullus lanatus |
| | | | Cucumis anguria |
| | | | Cucumis melo |
| | | | Cucumis sativus |
| | | | Cucurbita moschata × C. maxima |
| | | | Cucurbita pepo |
| | | | Cucurbita pepo var. Caserta |
| Picornavirales | Secoviridae | Comovirus | Turnip ringspot virus |
| | | unclassif. | |
| | | | Eruca sativa |
| Picornavirales | Secoviridae | Nepovirus | Grapevine fanleaf virus |
| | | | Vitis vinifera |
| Picornavirales | Secoviridae | Nepovirus | Hibiscus latent ringspot virus |
| | | | Hibiscus rosa-sinensis |
| Picornavirales | Secoviridae | Nepovirus | Tobacco ringspot virus |
| | | | Cucurbita pepo var. Caserta |
| Picornavirales | Secoviridae | Nepovirus | Tomato ringspot virus |
| | | | Rubus spp. |
| | | | Solanum tuberosum |
| Picornavirales | Secoviridae | Waikavirus | Maize chlorotic dwarf virus |
| | | | Brachiaria sp. |
| | | | Panicum sp. |
| Picornavirales | Secoviridae | | Dioscorea mosaic associated |
| | | | virus |
| | | | Dioscorea spp. |
| Picornavirales | Secoviridae | | Strawberry mottle virus |
| | | | Fragaria × ananassa |
| Picornavirales | Secoviridae | | Lettuce mottle virus |
| | putative | | |
| | | | Lactuca sativa |
| Tymovirales | Alphaflexiviridae | Allexivirus | Garlic mite-borne filamentous |
| | | | virus |
| | | | Allium sativum |
| Tymovirales | Alphaflexiviridae | Allexivirus | Garlic virus A |
| | | | Allium sativum |
| Tymovirales | Alphaflexiviridae | Allexivirus | Garlic virus B |
| | | | Allium sativum |
| Tymovirales | Alphaflexiviridae | Allexivirus | Garlic virus C |
| | | | Allium sativum |
| Tymovirales | Alphaflexiviridae | Allexivirus | Garlic virus D |
| | | | Allium sativum |
| Tymovirales | Alphaflexiviridae | Allexivirus | Garlic virus X |
| | | | Allium sativum |
| Tymovirales | Alphaflexiviridae | Potexvirus | Alternanthera mosaic virus |
| | | | Angelonia sp. |
| | | | Helichrysum sp. |
| | | | Portulaca oleracea |
| | | | Salvia splendens |
| | | | Scutellaria sp. |
| | | | Torenia sp. |
| Tymovirales | Alphaflexiviridae | Potexvirus | Bamboo mosaic virus |
| | | | Bambusa vulgaris |
| Tymovirales | Alphaflexiviridae | Potexvirus | Cactus virus X |
| | | | Several cactaceae species |
| Tymovirales | Alphaflexiviridae | Potexvirus | Cassava common mosaic virus |
| | | | Manihot esculenta |
| Tymovirales | Alphaflexiviridae | Potexvirus | Cymbidium mosaic virus |
| | | | Orchid (several genera) |
| Tymovirales | Alphaflexiviridae | Potexvirus | Hydrangea ringspot virus |
| | | | Hydrangea macrophylla |
| Tymovirales | Alphaflexiviridae | Potexvirus | Malva mosaic virus |
| | | | Malva parviflora |
| Tymovirales | Alphaflexiviridae | Potexvirus | Opuntia virus X |
| | | | Several cactaceae species |
| Tymovirales | Alphaflexiviridae | Potexvirus | Potato aucuba mosaic virus |
| | | | Solanum tuberosum |
| Tymovirales | Alphaflexiviridae | Potexvirus | Potato virus X |
| | | | Solanum tuberosum |
| Tymovirales | Alphaflexiviridae | Potexvirus | Schlumbergera virus X |
| | | | Several cactaceae species |
| Tymovirales | Alphaflexiviridae | Potexvirus | White clover mosaic virus |
| | | | Trifolium sp. |
| Tymovirales | Alphaflexiviridae | Potexvirus | Zygocactus virus X |
| | | | Several cactaceae species |
| Tymovirales | Alphaflexiviridae | Potexvirus | Caladium virus X |
| | | unclassif. | |
| | | | Caladium bicolor |
| Tymovirales | Alphaflexiviridae | Potexvirus | Patchouli virus X |
| | | unclassif. | |
| | | | Pogostemum patchouly |
| Tymovirales | Alphaflexiviridae | Potexvirus | Senna virus X |
| | | unclassif. | |
| | | | Senna occidentalis |
| Tymovirales | Betaflexiviridae | Carlavirus | Cole latent virus |
| | | | Armoracia rusticana |
| | | | Brassica spp. |
| Tymovirales | Betaflexiviridae | Carlavirus | Cowpea mild mottle virus |
| | | | Glycine max |
| | | | Phaseolus vulgaris |
| Tymovirales | Betaflexiviridae | Carlavirus | Garlic common latent virus |
| | | | Allium sativum |
| Tymovirales | Betaflexiviridae | Carlavirus | Melon yellowing-associated virus |
| | | | Cucumis melo |
| Tymovirales | Betaflexiviridae | Carlavirus | Potato virus M |
| | | | Solanum tuberosum |
| Tymovirales | Betaflexiviridae | Carlavirus | Potato virus S |
| | | | Solanum tuberosum |
| Tymovirales | Betaflexiviridae | Carlavirus | Shallot latent virus |
| | | | Allium sativum |
| Tymovirales | Betaflexiviridae | Carlavirus | Sweet potato C6 virus |
| | | | Ipomea batatas |
| Tymovirales | Betaflexiviridae | Carlavirus | Sweet potato chlorotic fleck virus |
| | | | Ipomea batatas |
| Tymovirales | Betaflexiviridae | Carlavirus | Cassia mild mosaic virus |
| | | unclassif. | |
| | | | Cassia macranthera |
| | | | Cassia sylvestris |
| Tymovirales | Betaflexiviridae | Carlavirus | Carlavirus (unidentif.) |
| | | unclassif. | |
| | | | Allium ascalonicum |
| | | | Alstroemeria sp. |
| | | | Hevea brasiliensis |
| Tymovirales | Betaflexiviridae | Foveavirus | Apple stem pitting virus |
| | | | Malus sp. |
| | | | Pyrus communis |
| Tymovirales | Betaflexiviridae | Foveavirus | Grapevine rupestris stem pitting- |
| | | | associated virus |
| | | | Vitis vinifera |
| Tymovirales | Betaflexiviridae | Capillovirus | Apple stem grooving virus |
| | | | Citrus spp. |
| | | | Malus sp. |
| Tymovirales | Betaflexiviridae | Trichovirus | Apple chlorotic leaf spot virus |
| | | | Malus sp. |
| Tymovirales | Betaflexiviridae | Vitivirus | Arracacha virus V |
| | | | Arracacia xanthorhiza |
| Tymovirales | Betaflexiviridae | Vitivirus | Grapevine virus A |
| | | | Passiflora alata |
| | | | Vitis vinifera |
| Tymovirales | Betaflexiviridae | Vitivirus | Grapevine virus B |
| | | | Vitis vinifera |
| Tymovirales | Tymoviridae | Maculavirus | Grapevine fleck virus |
| | | | Vitis vinifera |
| Tymovirales | Tymoviridae | Marafivirus | Citrus sudden death-associated |
| | | | virus |
| | | | Citrus spp. |
| Tymovirales | Tymoviridae | Marafivirus | Maize rayado fino virus |
| | | | Zea mays |
| Tymovirales | Tymoviridae | Marafivirus | Grapevine rupestris vein |
| | | unclassif. | feathering virus |
| | | | Vitis vinifera |
| Tymovirales | Tymoviridae | Tymovirus | Eggplant mosaic virus |
| | | | Peperomia obtusifolia |
| | | | Solanum lycopersicum |
| Tymovirales | Tymoviridae | Tymovirus | Passion fruit yellow mosaic virus |
| | | | Passiflora edulis f. flavicarpa |
| Tymovirales | Tymoviridae | Tymovirus | Petunia vein banding virus |
| | | | Petunia × hybrida |
| Tymovirales | Tymoviridae | Tymovirus | Tomato blistering mosaic |
| | | | tymovirus |
| | | | Nicotiana tabacum |
| | | | Solanum lycopersicum |
| | | | Solanum violifolium |
| Tymovirales | Tymoviridae | Tymovirus | Cassia yellow mosaic associated |
| | | unclassif. | virus |
| | | | Cassia hoffmannseggii |
| Tymovirales | Tymoviridae | Tymovirus | Senna virus X |
| | | unclassif. | |
| | | | Cassia macranthera |
| Tymovirales | Tymoviridae | Tymovirus | Tymovirus (unident.) |
| | | unclassif. | |
| | | | Lactuca sativa |
| — | Amalgaviridae | Amalgavirus | Amalgavirus (unident.) |
| | | unclassif. | |
| | | | Solanum lycopersicum |
| — | Benyviridae | Benyvirus | Beet necrotic yellow vein virus |
| | | | Beta vulgaris L., subsp. Vulgaris |
| — | Benyviridae | Benyvirus | Rice stripe necrosis virus |
| | | | Oryza sativa |
| — | Bromoviridae | Alfamovirus | Alfalfa mosaic virus |
| | | | Carica papaya |
| | | | Glycine max |
| | | | Mendicago sativa |
| | | | Solanum tuberosum |
| | | | Stizolobium aterrimum |
| | | | Trifolium sp. |
| — | Bromoviridae | Bromovirus | Brome mosaic virus |
| | | | Triticum aestivum |
| — | Bromoviridae | Cucumovirus | Cucumber mosaic virus |
| | | | Acmella oleracea |
| | | | Aeschynanthus pulmer |
| | | | Allamanda cathartica |
| | | | Alstroemeria sp. |
| | | | Andira vermifuga |
| | | | Anthurium spp. |
| | | | Arachis repens |
| | | | Asclepias curassavica |
| | | | Brassica napus |
| | | | Caesalpinia echinata |
| | | | Calopogonium mucunoides |
| | | | Capsicum annuum |
| | | | Capsicum frutescens |
| | | | Catharanthus roseus |
| | | | Citrullus lanatus |
| | | | Cleome affinis |
| | | | Commelina spp |
| | | | Cucumis anguria |
| | | | Cucumis melo |
| | | | Cucumis metuliferus |
| | | | Cucumis sativus |
| | | | Cucurbita pepo |
| | | | Cucurbita pepo var. Caserta |
| | | | Cyclanthera pedata |
| | | | Desmodium sp. |
| | | | Eucharis grandiflora |
| | | | Eustoma grandiflorum |
| | | | Gladiolus × hortulanus |
| | | | Gloxinia sylvatica |
| | | | Impatiens spp. |
| | | | Justicia sp. |
| | | | Lactuca sativa |
| | | | Lilium sp. |
| | | | Momordica charantia |
| | | | Musa spp. |
| | | | Nasturtium officinale |
| | | | Nematanthus sp. |
| | | | Nicotiana tabacum |
| | | | Ocimum campechianum |
| | | | Orchid (Dendrobium) |
| | | | Passiflora edulis f. flavicarpa |
| | | | Peperomia caperata |
| | | | Phaseolus lunatus |
| | | | Phaseolus vulgaris |
| | | | Piper nigrum |
| | | | Pisum sativum |
| | | | Salvia splendens |
| | | | Solanum americanum |
| | | | Solanum lycopersicum |
| | | | Solanum nigrum |
| | | | Solalnum paniculatum |
| | | | Spinacia oleracea |
| | | | Strelitzia reginae |
| | | | Tetragonia expansa |
| | | | Tradescantia diuretica |
| | | | Vanilla planifolia |
| | | | Vigna unguiculata |
| | | | Zea mays |
| | | | Zeyheria tuberculosa |
| | | | Zingiber officinale |
| — | Bromoviridae | Ilarvirus | Apple mosaic virus |
| | | | Prunus persica |
| | | | Prunus persica var. nucipersica |
| — | Bromoviridae | Ilarvirus | Prune dwarf virus |
| | | | Prunus persica |
| | | | Prunus persica var. nucipersica |
| — | Bromoviridae | Ilarvirus | Prunus necrotic ringspot virus |
| | | | Prunus persica |
| | | | Prunus salicina |
| | | | Rosa spp. |
| — | Bromoviridae | Ilarvirus | Tobacco streak virus |
| | | | Alstroemeria sp. |
| | | | Ambrosia polystachya |
| | | | Apium graveolens |
| | | | Cynara scolymus |
| | | | Dahlia variabilis |
| | | | Eustoma grandiflorum |
| | | | Fragaria × ananassa |
| | | | Glycine max |
| | | | Gossypium hirsutum |
| | | | Helianthus annuus |
| | | | Nicotiana tabacum |
| | | | Phaseolus vulgaris |
| | | | Solanum lycopersicum |
| | | | Solanum tuberosum |
| | | | Talinum patense |
| — | Bromoviridae | Ilarvirus unclassif. | Ilarvirus (unidentif.) |
| | | | Chrysanthemum morifolium |
| | | | Euphorbia splendens |
| — | Closteroviridae | Ampelovirus | Grapevine leafroll-associated |
| | | | virus 1 |
| | | | Vitis vinifera |
| — | Closteroviridae | Ampelovirus | Grapevine leafroll-associated |
| | | | virus 3 |
| | | | Vitis vinifera |
| — | Closteroviridae | Ampelovirus | Grapevine leafroll-associated |
| | | | virus 4 |
| | | | Vitis vinifera |
| — | Closteroviridae | Ampelovirus | Pineapple mealybug wilt- |
| | | | associated virus 1 |
| | | | Ananas sativus |
| — | Closteroviridae | Ampelovirus | Pineapple mealybug wilt- |
| | | | associated virus 2 |
| | | | Ananas sativus |
| — | Closteroviridae | Ampelovirus | Pineapple mealybug wilt- |
| | | | associated virus 3 |
| | | | Ananas sativus |
| | | Ampelovirus | Grapevine leafroll-associated |
| | | unclassif | virus 5 |
| | | | Vitis vinifera |
| | | Ampelovirus | Grapevine leafroll-associated |
| | | unclassif. | virus 6 |
| | | | Vitis vinifera |
| — | Closteroviridae | Closterovirus | Citrus tristeza virus |
| | | | Citrus spp. |
| — | Closteroviridae | Closterovirus | Grapevine leafroll-associated |
| | | | virus 2 |
| | | | Vitis vinifera |
| | | Closterovirus | Closterovirus unident. |
| | | unclassif. | |
| | | | Arracacia xanthorhiza |
| — | Closteroviridae | Crinivirus | Sweet potato chlorotic stunt virus |
| | | | Ipomea batatas |
| — | Closteroviridae | Crinivirus | Tomato chlorosis virus |
| | | | Capsicum annuum |
| | | | Eruca sativa |
| | | | Physalis angulata |
| | | | Raphanus sp. |
| | | | Solanum aethiopicum |
| | | | Solanum lycopersicum |
| | | | Solanum melongena |
| | | | Solanum tuberosum |
| — | Endornaviridae | Alphaendornavirus | Phaseolus vulgaris |
| | | | alphaendornavirus 1 |
| | | | Phaseolus vulgaris |
| — | Endornaviridae | Alphaendornavirus | Phaseolus vulgaris |
| | | | alphaendornavirus 2 |
| | | | Phaseolus vulgaris |
| — | Kitaviridae | Cilevirus | Citrus leprosis virus C |
| | | | Citrus spp. |
| — | Kitaviridae | Cilevirus putative | Ligustrum leprosis virus |
| | | | Ligustrum spp. |
| — | Kitaviridae | Cilevirus putative | Passion fruit green spot virus |
| | | | Passiflora edulis f. flavicarpa |
| — | Kitaviridae | Cilevirus putative | Solanum violifolium ringspot |
| | | | virus |
| | | | Solanum violifolium |
| | | | Unxia kubitzki |
| — | Kitaviridae | Cilevirus putative | Cilevirus (unidentified) |
| | | | Anthurium spp. |
| | | | Beaumontia grandifolia |
| | | | Brunfelsia uniflora |
| | | | Clerodendrum spp. |
| | | | Cordyline terminalis |
| | | | Dracaena marginata |
| | | | Eugenia uniflora |
| | | | Hedera canariensis |
| | | | Hibiscus spp. |
| | | | Lysimachia congestiflora |
| | | | Orchid (several genera) |
| | | | Pelargonium hortorum |
| | | | Plumbago auriculata |
| | | | Salvia leucantha |
| | | | Schefflera actinophylla |
| | | | Spathiphyllum wallisii |
| | | | Thunbergia erecta |
| | Luteoviridae | Enamovirus | Citrus vein enation virus |
| | | putative | |
| | | | Citrus spp. |
| — | Luteoviridae | Enamovirus | Grapevine enamolike virus |
| | | putative | |
| | | | Vitis vinifera |
| — | Luteoviridae | Luteovirus | Barley yellow dwarf virus PAV |
| | | | Avena sativa |
| | | | Triticum aestivum |
| — | Luteoviridae | Polerovirus | Beet western yellows virus |
| | | | Raphanus raphanistrum |
| | Luteoviridae | Polerovirus | Carrot red leaf virus |
| | | | Daucus carota |
| | Luteoviridae | Polerovirus | Cotton leafroll dwarf virus |
| | | | Gossypium hirsutum |
| | Luteoviridae | Polerovirus | Maize yellow mosaic virus |
| | | | Zea mays |
| | Luteoviridae | Polerovirus | Melon aphid-borne yellows virus |
| | | | Cucumis melo |
| — | Luteoviridae | Polerovirus | Potato leafroll virus |
| | | | Ambrosia elatior |
| | | | Bidens pilosa |
| | | | Capsicum annuum |
| | | | Conyza canadensis |
| | | | Datura stramonium |
| | | | Galinsoga parviflora |
| | | | Physalis floridana |
| | | | Solanum aculeatissimum |
| | | | Solanum lycopersicum |
| | | | Solanum melongena |
| | | | Solanum nigrum |
| | | | Solalnum paniculatum |
| | | | Solanum tuberosum |
| | | | Solanum variabile |
| | | | Solanum viarum |
| | | | Vernonia polyantes |
| — | Luteoviridae | Polerovirus | Sugar cane yellow leaf virus |
| | | | Saccharum officinarum |
| — | Luteoviridae | Polerovirus | Cotton anthocyanosis virus |
| | | putative | |
| | | | Gossypium hirsutum |
| | | | Cotton vein mosaic virus |
| | | | Gossypium hirsutum |
| — | Pospiviroidae | Apscaviroid | Citrus dwarfing viroid |
| | | | Citrus spp. |
| — | Pospiviroidae | Apscaviroid | Grapevine yellow speckle viroid 1 |
| | | | Vitis vinifera |
| — | Pospiviroidae | Coleviroid | Coleus blumei viroid 1 |
| | | | Coleus blumei |
| — | Pospiviroidae | Hostuviroid | Hop stunt viroid |
| | | | Vitis vinifera |
| — | Pospiviroidae | Pospiviroid | Chrysanthemum stunt viroid |
| | | | Chrysanthemum sp. |
| | | | Chrysanthemum morifolium |
| | | | Citrus spp. |
| | | | Vitis vinifera |
| — | Pospiviroidae | Pospiviroid | Citrus exocortis viroid |
| | | | Citrus spp. |
| | | | Vitis vinifera |
| — | Potyviridae | Brambyvirus | Stylosanthes mosaic associated |
| | | putative | virus 1 |
| | | | Stylosanthes guianensis |
| | Potyviridae | Brambyvirus | Stylosanthes mosaic associated |
| | | putative | virus 2 |
| | | | Stylosanthes guianensis |
| | Potyviridae | Brambyvirus | Stylosanthes mosaic associated |
| | | putative | virus 3 |
| | | | Stylosanthes guianensis |
| — | Potyviridae | Bymovirus | Wheat spindle streak mosaic virus |
| | | | Triticum aestivum |
| | Potyviridae | Ipomovirus | Sweet potato mild mottle virus |
| | | | Ipomea batatas |
| | Potyviridae | Macluravirus | Artichoke latent virus |
| | | | Cynara scolymus |
| | Potyviridae | Potyvirus | Alstroemeria mosaic virus |
| | | | Alstroemeria sp. |
| | Potyviridae | Potyvirus | Arracacha mottle virus |
| | | | Arracacia xanthorhiza |
| | Potyviridae | Potyvirus | Bean common mosaic virus |
| | | | Cyamopsis tetragonolobus |
| | | | Lens culinaria |
| | | | Phaseolus vulgaris |
| | | | Senna occidentalis |
| | | | Vigna radiata |
| | Potyviridae | Potyvirus | Bean yellow mosaic virus |
| | | | Arachis hypogaea |
| | | | Gladiolus × hortulanus |
| | | | Glycine max |
| | | | Hippeastrum sp. |
| | | | Lilium sp. |
| | | | Lupinus alba |
| | | | Phaseolus vulgaris |
| | | | Pisum sativum |
| | Potyviridae | Potyvirus | Bidens mosaic virus |
| | | | Arracacia xanthorhiza |
| | | | Bidens pilosa |
| | | | Coreopsis lanceolata |
| | | | Galinsoga parviflora |
| | | | Helianthus annuus |
| | | | Lactuca sativa |
| | | | Pisum sativum |
| | | | Zinnia elegans |
| | Potyviridae | Potyvirus | Brugmansia suaveolens mottle |
| | | | virus |
| | | | Brugmansia suaveolens |
| | Potyviridae | Potyvirus | Canna yellow streak virus |
| | | | Canna paniculata |
| | Potyviridae | Potyvirus | Carrot thin leaf virus |
| | | | Daucus carota |
| | Potyviridae | Potyvirus | Catharanthus mosaic virus |
| | | | Catharanthus roseus |
| | Potyviridae | Potyvirus | Celery mosaic virus |
| | | | Apium graveolens |
| | | | Petroselinum sativum |
| | Potyviridae | Potyvirus | Cowpea aphid-borne mosaic virus |
| | | | Arachis hypogaea |
| | | | Canavalia ensiformes |
| | | | Canavalia rosea |
| | | | Cassia hoffmannseggii |
| | | | Crotalaria juncea |
| | | | Desmodium sp. |
| | | | Glycine max |
| | | | Passiflora edulis f. flavicarpa |
| | | | Passiflora coccinea × P. setacea |
| | | | Phaseolus lunatus |
| | | | Phaseolus vulgaris |
| | | | Senna occidentalis |
| | | | Sesamum indicum |
| | | | Thunbergia alata |
| | | | Vigna unguiculata |
| | | | Vigna |
| | | | unguiculata subsp. Sesquipedalis |
| | Potyviridae | Potyvirus | Dasheen mosaic virus |
| | | | Alocasia macrorhizos |
| | | | Amorphophallus konjac |
| | | | Anthurium spp. |
| | | | Caladium bicolor |
| | | | Colocasia esculenta |
| | | | Dieffenbachia amoena |
| | | | Syngonium wendlandii |
| | | | Xanthosoma atrovirens |
| | | | Zantedeschia aethiopica |
| | Potyviridae | Potyvirus | Hippeastrum mosaic virus |
| | | | Eucharis grandiflora |
| | | | Hippeastrum sp. |
| | Potyviridae | Potyvirus | Hyacinth mosaic virus |
| | | | Hyacinthus orientalis |
| | Potyviridae | Potyvirus | Johnson grass mosaic virus |
| | | | Brachiaria sp. |
| | | | Panicum maximum |
| | | | Pennisetum purpureum |
| | | | Sorghum bicolor |
| | | | Zea mays |
| | Potyviridae | Potyvirus | Konjac mosaic virus |
| | | | Zamioculcas zamiifolia |
| | Potyviridae | Potyvirus | Leek yellow stripe virus |
| | | | Allium sativum |
| | Potyviridae | Potyvirus | Lettuce mosaic virus |
| | | | Cichorium endivia |
| | | | Erigeron bonariensis |
| | | | Galinsoga parviflora |
| | | | Lactuca sativa |
| | | | Sonchus asper |
| | | | Sonchus oleraceus |
| | Potyviridae | Potyvirus | Maize dwarf mosaic virus |
| | | | Zea mays |
| | Potyviridae | Potyvirus | Malva vein clearing virus |
| | | | Malva parviflora |
| | Potyviridae | Potyvirus | Onion yellow dwarf virus |
| | | | Allium cepa |
| | | | Allium fistulosum |
| | | | Allium sativum |
| | Potyviridae | Potyvirus | Papaya ringspot virus |
| | | | Carica papaya |
| | | | Citrullus lanatus |
| | | | Cucumis anguria |
| | | | Cucumis melo |
| | | | Cucumis metuliferus |
| | | | Cucumis sativus |
| | | | Cucurbita maxima |
| | | | Cucurbita moschata |
| | | | Cucurbita pepo var. Caserta |
| | | | Cyclanthera pedata |
| | | | Fevillea trilobata |
| | | | Luffa operculata |
| | | | Psiguria triphylla |
| | | | Zeyheria tuberculosa |
| | Potyviridae | Potyvirus | Pea seed-borne mosaic virus |
| | | | Pisum sativum |
| | Potyviridae | Potyvirus | Peanut mottle virus |
| | | | Arachis hypogaea |
| | | | Arachis pintoi |
| | Potyviridae | Potyvirus | Pepper mottle virus |
| | | | Capsicum frutescens |
| | Potyviridae | Potyvirus | Pepper yellow mosaic virus |
| | | | Caesalpinia echinata |
| | | | Capsicum annuum |
| | | | Capsicum baccatum |
| | | | Capsicum chinense |
| | | | Solanum lycopersicum |
| | Potyviridae | Potyvirus | Pfaffia mosaic virus |
| | | | Pfaffia glomerata |
| | Potyviridae | Potyvirus | Potato virus A |
| | | | Solanum tuberosum |
| | Potyviridae | Potyvirus | Potato virus Y |
| | | | Amaranthus sp. |
| | | | Bidens pilosa |
| | | | Caesalpinia echinata |
| | | | Capsicum annuum |
| | | | Capsicum baccatum |
| | | | Capsicum frutescens |
| | | | Conyza canadensis |
| | | | Emilia sonchifolia |
| | | | Galinsoga parviflora |
| | | | Gnaphalium spicatum |
| | | | Nicandra physaloides |
| | | | Nicotiana tabacum |
| | | | Physalis angulata |
| | | | Physalis peruviana |
| | | | Phytolacca decandra |
| | | | Solanum aculeatissimum |
| | | | Solanum americanum |
| | | | Solanum atropurpureum |
| | | | Solanum lycopersicum |
| | | | Solanum melongena |
| | | | Solanum nigrum |
| | | | Solanum palinacanthum |
| | | | Solalnum paniculatum |
| | | | Solanum tuberosum |
| | | | Solanum viarum |
| | | | Sonchus oleraceus |
| | | | Vernonia polyantes |
| | | | Viola odorata |
| | | | Zanthosylum rhoifolium |
| | | | Zeyheria tuberculosa |
| | Potyviridae | Potyvirus | Soybean mosaic virus |
| | | | Glycine max |
| | | | Senna occidentalis |
| | Potyviridae | Potyvirus | Sugar cane mosaic virus |
| | | | Cymbopogon winterianus |
| | | | Saccharum officinarum |
| | | | Sorghum bicolor |
| | | | Zea mays |
| | Potyviridae | Potyvirus | Sunflower chlorotic mottle virus |
| | | | Zinnia elegans |
| | Potyviridae | Potyvirus | Sweet potato feathery mottle virus |
| | | | Ipomea batatas |
| | Potyviridae | Potyvirus | Sweet potato latent virus |
| | | | Ipomea batatas |
| | Potyviridae | Potyvirus | Sweet potato mild speckling virus |
| | | | Ipomea batatas |
| | Potyviridae | Potyvirus | Sweet potato virus G |
| | | | Ipomea batatas |
| | Potyviridae | Potyvirus | Tobacco etch virus |
| | | | Solanum lycopersicum |
| | Potyviridae | Potyvirus | Tulip breaking virus |
| | | | Lilium sp. |
| | Potyviridae | Potyvirus | Turnip mosaic virus |
| | | | Armoracia rusticana |
| | | | Brassica carinata |
| | | | Brassica oleracea |
| | | | B. rapa |
| | | | Brassica napus |
| | | | Nasturtium officinale |
| | | | Raphanus raphanistrum |
| | | | Sinapsis alba |
| | | | Spinacia oleracea |
| | | | Tropaeolum majus |
| | Potyviridae | Potyvirus | Watermelon mosaic virus |
| | | | Caesalpinia echinata |
| | | | Citrullus lanatus |
| | | | Cucumis melo |
| | | | Cucurbita moschata |
| | | | Cucurbita pepo var. Caserta |
| | | | Cybistax antisyphilitica |
| | Potyviridae | Potyvirus | Yam mild mosaic virus |
| | | | Dioscorea spp. |
| | Potyviridae | Potyvirus | Yam mosaic virus |
| | | | Dioscorea spp. |
| | Potyviridae | Potyvirus | Zucchini yellow mosaic virus |
| | | | Benincasa hispida |
| | | | Caesalpinia echinata |
| | | | Cayaponia tibiricae |
| | | | Citrullus lanatus |
| | | | Cucumis anguria |
| | | | Cucumis melo |
| | | | Cucumis sativus |
| | | | Cucurbita pepo var. Caserta |
| | | | Cybistax antisyphilitica |
| | | | Luffa cylindrica |
| | | | Sicana odorifera |
| | | | Trichosanthes cucumerina |
| | Potyviridae | Tritimovirus | Wheat streak mosaic virus |
| | | | Triticum aestivum |
| | Potyviridae | | Elephant grass mosaic virus |
| | putative | | |
| | | | Pennisetum purpureum |
| | Potyviridae | | Cotylendon Y virus |
| | putative | | |
| | | | Cotyledon orbiculata |
| | Potyviridae | | Senna virus Y |
| | putative | | |
| | | | Cassia macranthera |
| | | | Cassia sylvestris |
| | Potyviridae | | Potyviridae unidentified |
| | putative | | |
| | | | Allium ascalonicum |
| | | | Alternanthera tenella |
| | | | Centrosema pubescens |
| | | | Chrysanthemum frutescens |
| | | | Cichorium intybus |
| | | | Clitoria ternatea |
| | | | Commelina spp |
| | | | Crinum sp. |
| | | | Crotalaria juncea |
| | | | Cucurbita pepo var. Caserta |
| | | | Digitaria sanguinalis |
| | | | Heliconia stricta |
| | | | Hypochaeris brasiliensis |
| | | | Impatiens spp. |
| | | | Kalanchoe sp. |
| | | | Macroptilum atropurpureum |
| | | | Paspalum conjugatum |
| | | | Phaseolus vulgaris |
| | | | Pogostemum patchouly |
| | | | Rhoe discolor |
| | | | Stylosanthes guianensis |
| | | | Stylosanthes scabra |
| | | | Tulipa sp. |
| — | Reoviridae | Fijivirus | Mal de Rio Cuarto virus |
| | | | Zea mays |
| | Reoviridae | Fijivirus | Pangola stunt virus |
| | | | Digitaria decumbens |
| | Reoviridae | | Cassava frogskin disease |
| | putative | | associated virus |
| | | | Manihot esculenta |
| | Reoviridae | | Grapevine Cabernet sauvignon |
| | putative | | virus |
| | | | Vitis vinifera |
| — | Solemoviridae | Sobemovirus | Papaya lethal yellowing virus |
| | | | Carica papaya |
| | Solemoviridae | Sobemovirus | Southern bean mosaic virus |
| | | | Glycine max |
| | | | Phaseolus vulgaris |
| | Solemoviridae | Sobemovirus | Sowbane mosaic virus |
| | | | Chenopodium murale |
| — | Tombusviridae | Alphacarmovirus | Carnation mottle virus |
| | | | Dianthus caryophyllus |
| | Tombusviridae | Alphanecrovirus | Tobacco necrosis virus A |
| | | | Bidens pilosa |
| | | | Brassica oleracea var. gemmifera |
| | | | Carica papaya |
| | | | Fragaria × ananassa |
| | | | Helianthus annuus |
| | | | Manihot esculenta |
| | | | Nicotiana tabacum |
| | | | Pogostemum patchouly |
| | | | Solanum lycopersicum |
| | Tombusviridae | Alphanecrovirus | Squash necrosis virus |
| | | putative | |
| | | | Cucurbita pepo |
| | Tombusviridae | Betacarmovirus | Hibiscus chlorotic ringspot virus |
| | | | Hibiscus rosa sinensis |
| | Tombusviridae | Umbravirus | Papaya meleira virus 2 |
| | | putative | |
| | | | Carica papaya |
| — | Totiviridae | Totivirus putative | Papaya meleira virus |
| | | | Carica papaya |
| — | Virgaviridae | Furovirus | Soil-borne wheat mosaic virus |
| | | | Triticum aestivum |
| | Virgaviridae | Hordeivirus | Barley stripe mosaic virus |
| | | | Hordeum vulgare |
| | Virgaviridae | Tobamovirus | Hibiscus latent Fort Pierce virus |
| | | | Hibiscus rosa-sinensis |
| | Virgaviridae | Tobamovirus | Odontoglossum ringspot virus |
| | | | Orchid (several genera) |
| | Virgaviridae | Tobamovirus | Pepper mild mottle virus |
| | | | Caesalpinia echinata |
| | | | Capsicum annuum |
| | | | Capsicum frutescens |
| | | | Couroupita guianensis |
| | | | Eriotheca pubescens |
| | | | Matayba ealeagnoides |
| | | | Psycothria mapourioides |
| | | Sclerolobium melinonii | |
| | Virgaviridae | Tobamovirus | Sunn-hemp mosaic virus |
| | | | Cicer arietinum |
| | | | Crotalaria juncea |
| | Virgaviridae | Tobamovirus | Tobacco mosaic virus |
| | | | Caesalpinia echinata |
| | | | Capsicum annuum |
| | | | Dieffenbachia amoena |
| | | | Impatiens hawkeri |
| | | | Nicotiana tabacum |
| | | | Petunia × hybrida |
| | | | Solanum lycopersicum |
| | | | Zinnia elegans |
| | Virgaviridae | Tobamovirus | Tomato mosaic virus |
| | | | Capsicum annuum |
| | | | Hemerocallis sp. |
| | | | Solanum lycopersicum |
| | Virgaviridae | Tobamovirus | Tomato mottle mosaic virus |
| | | | Solanum lycopersicum |
| | Virgaviridae | Tobamovirus | Tobamovirus (unidentif.) |
| | | putative | |
| | | | Calibrachoa sp. |
| | | | Ocimum basilicum |
| | | | Physalis angulata |
| | | | Rhoe discolor |
| | | | Torenia sp. |
| | | | Verbena sp. |
| | Virgaviridae | Tobravirus | Pepper ringspot virus |
| | | | Capsicum annuum |
| | | | Cynara scolymus |
| | | | Eustoma grandiflorum |
| | | | Gerbera jamesonii |
| | | | Gloxinia sylvatica |
| | | | Pogostemum patchouly |
| | | | Solanum lycopersicum |
| | | | Solanum tuberosum |
| | | | Solanum violifolium |
| | Virgaviridae | Tobravirus | Tobacco rattle virus |
| | | | Solanum tuberosum |
| DNA plant | | | |
| viruses | | | |
| Ortervirales | Caulimoviridae | Badnavirus | Banana streak OL virus |
| | | | Musa spp. |
| Ortervirales | Caulimoviridae | Badnavirus | Bougainvillea chlorotic vein |
| | | | banding virus |
| | | | Bougainvillea glabra |
| Ortervirales | Caulimoviridae | Badnavirus | Dioscorea bacilliform AL virus |
| | | | Dioscorea spp. |
| Ortervirales | Caulimoviridae | Badnavirus | Piper yellow mottle virus |
| | | | Piper nigrum |
| Ortervirales | Caulimoviridae | Badnavirus | Schefflera ringspot virus |
| | | | Schefflera actinophylla |
| Ortervirales | Caulimoviridae | Badnavirus | Sugar cane bacilliform IM virus |
| | | | Saccharum officinarum |
| Ortervirales | Caulimoviridae | Badnavirus | Sugar cane bacilliform MO virus |
| | | | Saccharum officinarum |
| | Caulimoviridae | Badnavirus | Sugar cane bacilliform BB virus |
| | | putative | |
| | | | Saccharum officinarum |
| | Caulimoviridae | Badnavirus | Sugar cane bacilliform Kerala |
| | | putative | |
| | | | Saccharum officinarum |
| | Caulimoviridae | Badnavirus | Badnavirus (unident.) |
| | | putative | |
| | | | Yucca elephantipes |
| Ortervirales | Caulimoviridae | Caulimovirus | Cauliflower mosaic virus |
| | | | Brassica oleracea, B. rapa |
| | | | Brassica napus |
| | | | Matthiola incana |
| | | | Nasturtium officinale |
| | | | Sinapsis alba |
| Ortervirales | Caulimoviridae | Caulimovirus | Dahlia mosaic virus |
| | | | Dahlia variabilis |
| Ortervirales | Caulimoviridae | Caulimovirus | Strawberry vein banding virus |
| | | | Fragaria × ananassa |
| | Caulimoviridae | Caulimovirus | Caulimovirus (Unidentif.) |
| | | putative | |
| | | | Beta vulgaris L. var. cicla |
| | | | Hibiscus rosa-sinensis |
| | | | Psidium guajava |
| Ortervirales | Caulimoviridae | Cavemovirus | Cassava vein mosaic virus |
| | | | Manihot esculenta |
| Ortervirales | Caulimoviridae | Cavemovirus | Sweet potato collusive virus |
| | | | Ipomea batatas |
| Ortervirales | Caulimoviridae | Petuvirus | Petunia vein clearing virus |
| | | | Petunia × hybrida |
| — | Geminiviridae | Begomovirus | Abutilon mosaic Brazil virus |
| | | | Abutilon striatum |
| | Geminiviridae | Begomovirus | Bean golden mosaic virus |
| | | | Galactia striata |
| | | | Glycine max |
| | | | Macroptilium erythroloma |
| | | | Macroptilium lathyroides |
| | | | Macroptilium longepedunculatum |
| | | | Phaseolus lunatus |
| | | | Phaseolus vulgaris |
| | Geminiviridae | Begomovirus | Blainvillea yellow spot virus |
| | | | Blainvillea rhomoboidea |
| | Geminiviridae | Begomovirus | Centrosema yellow spot virus |
| | | | Centrosema brasilianum |
| | Geminiviridae | Begomovirus | Chino del tomate Amazonas virus |
| | | | Solanum lycopersicum |
| | Geminiviridae | Begomovirus | Cleome leaf crumple virus |
| | | | Cleome affinis |
| | Geminiviridae | Begomovirus | Cnidoscolus mosaic leaf |
| | | | deformation virus |
| | | | Cnidoscolus urens |
| | Geminiviridae | Begomovirus | Cotton chlorotic spot virus |
| | | | Gossypium hirsutum |
| | Geminiviridae | Begomovirus | Cowpea golden mosaic virus |
| | | | Vigna unguiculata |
| | Geminiviridae | Begomovirus | Euphorbia mosaic virus |
| | | | Solanum lycopersicum |
| | Geminiviridae | Begomovirus | Euphorbia yellow mosaic virus |
| | | | Euphorbia heterophyla |
| | | | Glycine max |
| | | | Macroptilum atropurpureum |
| | | | Phaseolus vulgaris |
| | Geminiviridae | Begomovirus | Macroptilium yellow spot virus |
| | | | Calopogonium mucunoides |
| | | | Canavalia sp. |
| | | | Macroptilium lathyroides |
| | | | Phaseolus vulgaris |
| | Geminiviridae | Begomovirus | Melochia mosaic virus |
| | | | Melochia sp. |
| | Geminiviridae | Begomovirus | Melochia yellow mosaic virus |
| | | | Melochia sp. |
| | Geminiviridae | Begomovirus | Okra mottle virus |
| | | | Glycine max |
| | | | Solanum lycopersicum |
| | Geminiviridae | Begomovirus | Passionfruit severe leaf distortion |
| | | | virus |
| | | | Passiflora edulis f. flavicarpa |
| | Geminiviridae | Begomovirus | Pavonia mosaic virus |
| | | | Pavonia spp. |
| | Geminiviridae | Begomovirus | Pavonia yellow mosaic virus |
| | | | Pavonia spp. |
| | Geminiviridae | Begomovirus | Sida angular mosaic virus |
| | | | Sida spp |
| | Geminiviridae | Begomovirus | Sida bright yellow mosaic virus |
| | | | Sida spp |
| | Geminiviridae | Begomovirus | Sida chlorotic mottle virus |
| | | | Sida spp |
| | Geminiviridae | Begomovirus | Sida chlorotic vein virus |
| | | | Sida spp |
| | Geminiviridae | Begomovirus | Sida common mosaic virus |
| | | | Sida spp |
| | Geminiviridae | Begomovirus | Sida golden mosaic Brazil virus |
| | | | Sida spp |
| | Geminiviridae | Begomovirus | Sida micrantha mosaic virus |
| | | | Abelmoschus esculentus |
| | | | Capsicum chinense |
| | | | Glycine max |
| | | | Malva sp. |
| | | | Nicotiana tabacum |
| | | | Oxalis latifolia |
| | | | Phaseolus vulgaris |
| | | | Sida spp |
| | | | Solanum lycopersicum |
| | Geminiviridae | Begomovirus | Sida mosaic Alagoas virus |
| | | | Sida spp |
| | Geminiviridae | Begomovirus | Sida mottle Alagoas virus |
| | | | Sida spp |
| | Geminiviridae | Begomovirus | Sida mottle virus |
| | | | Glycine max |
| | | | Sida spp |
| | | | Solanum lycopersicum |
| | Geminiviridae | Begomovirus | Sida yellow leaf curl virus |
| | | | Sida spp |
| | Geminiviridae | Begomovirus | Sida yellow mosaic Alagoas virus |
| | | | Sida spp |
| | Geminiviridae | Begomovirus | Sida yellow net virus |
| | | | Solanum lycopersicum |
| | Geminiviridae | Begomovirus | Sweet potato leaf curl Sao Paulo |
| | | | virus |
| | | | Ipomea batatas |
| | Geminiviridae | Begomovirus | Tomato chlorotic mottle virus |
| | | | Solanum lycopersicum |
| | Geminiviridae | Begomovirus | Tomato golden leaf distortion |
| | | | virus |
| | | | Solanum lycopersicum |
| | Geminiviridae | Begomovirus | Tomato golden mosaic virus |
| | | | Solanum lycopersicum |
| | Geminiviridae | Begomovirus | Tomato golden vein virus |
| | | | Capsicum annuum |
| | | | Solanum lycopersicum |
| | Geminiviridae | Begomovirus | Tomato interveinal chlorosis virus |
| | | | Solanum lycopersicum |
| | Geminiviridae | Begomovirus | Tomato leaf distortion virus |
| | | | Solanum lycopersicum |
| | | | Solanum melongena |
| | Geminiviridae | Begomovirus | Tomato mild mosaic virus |
| | | | Solanum lycopersicum |
| | Geminiviridae | Begomovirus | Tomato mottle leaf curl virus |
| | | | Solanum lycopersicum |
| | | | Solanum melongena |
| | Geminiviridae | Begomovirus | Tomato rugose mosaic virus |
| | | | Capsicum annuum |
| | | | Capsicum baccatum |
| | | | Solanum lycopersicum |
| | Geminiviridae | Begomovirus | Tomato severe rugose virus |
| | | | Campomanesia adamantium |
| | | | Canavalia ensiformes |
| | | | Capsicum annuum |
| | | | Chenopodium album |
| | | | Glycine max |
| | | | Nicandra physaloides |
| | | | Nicotiana tabacum |
| | | | Phaseolus vulgaris |
| | | | Solanun commersonii |
| | | | Solanum lycopersicum |
| | | | Solanum tuberosum |
| | Geminiviridae | Begomovirus | Tomato yellow spot virus |
| | | | Leonurus sibiricus |
| | | | Solanum lycopersicum |
| | Geminiviridae | Begomovirus | Tomato yellow vein streak virus |
| | | | Nicandra physaloides |
| | | | Solanum lycopersicum |
| | Geminiviridae | Begomovirus | Triumfetta yellow mosaic virus |
| | | | Triumfetta semitriloba |
| | Geminiviridae | Begomovirus | “Encarquilhamento” |
| | | unclas. | |
| | | | Solanum lycopersicum |
| | Geminiviridae | Begomovirus | Engrujo |
| | | unclas. | |
| | | | Solanum lycopersicum |
| | Geminiviridae | Begomovirus | Gaya yellow mosaic virus |
| | | unclas. | |
| | | | Gaya guerkeana |
| | Geminiviridae | Begomovirus | Hyptis sp. Rugose mosaic virus 1 |
| | | unclas. | & 2 |
| | | | Hyptis sp. |
| | Geminiviridae | Begomovirus | “Infectious chlorosis of malvaceae |
| | | unclas. | complex” |
| | | | Abelmoschus esculentus |
| | | | Althaea rosea |
| | | | Glycine max |
| | | | Gossypium hirsutum |
| | | | Luehea grandiflora |
| | | | Malva parviflora |
| | | | Malvastrum coromandelianum |
| | | | Oxalis oxyptera |
| | | | Pavonia spp. |
| | | | Phaseolus vulgaris |
| | | | Phenax sonneratii |
| | | | Sida spp |
| | | | Solanum lycopersicum |
| | | | Triumfetta sp. |
| | | | Waltheria indica |
| | Geminiviridae | Begomovirus | Macroptilium yellow net virus |
| | | unclas. | |
| | | | Macroptilium lathyroides |
| | Geminiviridae | Begomovirus | Malvaviscus yellow mosaic virus |
| | | unclas. | |
| | | | Malvaviscus arboreus |
| | Geminiviridae | Begomovirus | Okra mosaic Mexico virus |
| | | unclas. | |
| | | | Malva sp. |
| | Geminiviridae | Begomovirus | Passion fruit little leaf mosaic |
| | | unclas. | virus |
| | | | Passiflora edulis f. flavicarpa |
| | Geminiviridae | Begomovirus | Physalis yellow spot virus |
| | | unclas. | |
| | | | Physalis sp. |
| | Geminiviridae | Begomovirus | Sida golden yellow mosaic virus |
| | | unclas. | |
| | | | Sida spp |
| | Geminiviridae | Begomovirus | Sida yellow spot virus |
| | | unclas. | |
| | | | Sida spp |
| | Geminiviridae | Begomovirus | Soybean chlorotic spot virus |
| | | unclas. | |
| | | | Glycine max |
| | Geminiviridae | Begomovirus | Sweet potato golden vein |
| | | unclas. | associated virus |
| | | | Ipomea batatas |
| | Geminiviridae | Begomovirus | Tomato chlorotic vein virus |
| | | unclas. | |
| | | | Solanum lycopersicum |
| | Geminiviridae | Begomovirus | Tomato crinkle virus |
| | | unclas. | |
| | | | Solanum lycopersicum |
| | Geminiviridae | Begomovirus | Tomato crinkle leaf yellows virus |
| | | unclas. | |
| | | | Macroptilum atropurpureum |
| | | | Solanum lycopersicum |
| | Geminiviridae | Begomovirus | Tomato infectious yellows virus |
| | | unclas. | |
| | | | Solanum lycopersicum |
| | Geminiviridae | Begomovirus | Tomato mild leaf curl virus |
| | | unclas. | |
| | | | Solanum lycopersicum |
| | Geminiviridae | Begomovirus | Tomato mosaic Barbados |
| | | unclas. | |
| | | | Solanum lycopersicum |
| | Geminiviridae | Begomovirus | Tomato severe mosaic virus |
| | | unclas. | |
| | | | Solanum lycopersicum |
| | Geminiviridae | Begomovirus | Tomato yellow mosaic virus |
| | | unclas. | |
| | | | Solanum lycopersicum |
| | Geminiviridae | Begomovirus | “Yellow net” |
| | | unclas. | |
| | | | Solanum lycopersicum |
| | Geminiviridae | Begomovirus | Begomovirus (unident.) |
| | | unclas. | |
| | | | Cardiopetalum calophyllum |
| | | | Clitoria fairchildiana |
| | | | Corchurus hirtus |
| | | | Herissantia crispa |
| | | | Hibiscus rosa-sinensis |
| | | | Ipomea sp. |
| | | | Lippia alba |
| | | | Macroptilium lathyroides |
| | | | Malva parviflora |
| | | | Physalis angulata |
| | | | Salvia splendens |
| | | | Sida spp |
| | | | Sidastrum micranthum |
| | | | Vigna luteola |
| | Geminiviridae | Curtovirus putative | Brazilian tomato curly top virus |
| | | | Acanthospermum hispidum |
| | | | Capsicum annuum |
| | | | Nicotiana tabacum |
| | | | Portulaca oleracea |
| | | | Solanum lycopersicum |
| | | | Solanum tuberosum |
| | Genomoviridae | Gemycircularvirus | Odonata associated |
| | | | gemycircularvirus 1 |
| | | | Momordica charanthia |
| | Nanoviridae | | Temperate fruit decay associated |
| | putative | | virus |
| | | | Malus sp. |
| | | | Pyrus communis |
| | | | Vitis vinifera |
| | Putative viral | | Purple grandadilla mosaic virus |
| | disease -isometric | | |
| | virion | | |
| | | | Passiflora edulis |
| | Putative viral | | Mimosa 62ensitive mosaic virus |
| | disease -isometric | | |
| | virion | | |
| | | | Mimosa sensitiva |
| | Putative viral | | unidentified |
| | disease -isometric | | |
| | virion | | |
| | | | Beaucarnea recurvata |
| | | | Caryocar brasiliense |
| | | | Diascia sp. |
| | Putative viral | | Citrus zonate chlorosis |
| | disease- unknown | | |
| | morphology | | |
| | | | Citrus spp. |
| | Putative viral | | Citrus cristacortis |
| | disease- unknown | | |
| | morphology | | |
| | | | Citrus spp. |
| | Putative viral | | Citrus rumple |
| | disease- unknown | | |
| | morphology | | |
| | | | Citrus spp. |
| | Putative viral | | Citrus vein enation |
| | disease- unknown | | |
| | morphology | | |
| | | | Citrus spp. |
| | Putative viral | | Citrus leaf curl |
| | disease- unknown | | |
| | morphology | | |
| | | | Citrus spp. |
| | Putative viral | | Grapevine LN33 stem grooving |
| | disease- unknown | | |
| | morphology | | |
| | | | Vitis vinifera |
| | Putative viral | | Grapevine vein necrosis |
| | disease- unknown | | |
| | morphology | | |
| | | | Vitis vinifera |
| | Putative viral | | Unidentified |
| | disease- unknown | | |
| | morphology | | |
| | | | Cydonia oblonga |
| | | | Ruta graveolens |
| | | | Senna bicapsularis |

In some embodiments, the viral infectious disease is induced by or involves a virus selected from: Picornavirales Secoviridae, Comovirus Cowpea mosaic virus, Fabavirus Broad bean wilt virus 1, Nepovirus Tobacco ringspot virus, Cheravirus Cherry rasp leaf virus, Sadwavirus Satsuma dwarf virus, Sequivirus Parsnip yellow fleck virus, Torradovirus Tomato torrado virus, Waikavirus Rice tungro spherical virus, Unassigned Black raspberry necrosis virus, Unassigned Chocolate lily virus A, Unassigned Dioscorea mosaic associated virus, Unassigned Strawberry latent ringspot virus, Unassigned Strawberry mottle virus, Tymovirales Alphaflexiviridae Allexivirus Shallot virus X, Lolavirus Lolium latent virus, Mandarivirus Indian citrus ringspot virus, Platypuvirus Donkey orchid symptomless virus, Potexvirus Potato virus X, Tymovirales Betaflexiviridae Carlavirus Carnation latent virus, Foveavirus Apple stem pitting virus, Robigovirus Cherry necrotic rusty mottle virus, Unassigned Banana mild mosaic virus, Unassigned Banana virus X, Unassigned Sugarcane striate mosaic associated virus, Capillovirus Apple stem grooving virus, Chordovirus Carrot Ch virus 1, Citrivirus Citrus leaf blotch virus, Divavirus Diuris virus A, Prunevirus Apricot vein clearing associated virus, Tepovirus Potato virus T, Trichovirus Apple chlorotic leaf spot virus, Vitivirus Grapevine virus A, Wamavirus Watermelon virus A, Tymovirales Tymoviridae Maculavirus Grapevine fleck virus, Marafivirus Maize rayado fino virus, Tymovirus Turnip yellow mosaic virus, Unassigned Poinsettia mosaic virus, Unassigned Benyviridae Benyvirus Beet necrotic yellow vein virus, Unassigned Botourmiaviridae Ourmiavirus Ourmia melon virus, Unassigned Bromoviridae Alfamovirus Alfalfa mosaic virus, Anulavirus Pelargonium zonate spot virus, Bromovirus Brome mosaic virus, Cucumovirus Cucumber mosaic virus, Ilarvirus Tobacco streak virus, or Oleavirus Olive latent virus 2.

In some embodiments, a viral disease is induced by or involves a virus belonging to the genus Ampelovirus.

In some embodiments, the viral disease is induced by a virus selected from grapevine leafroll associated viruses (GLRaV).

In some embodiments, the virus is: GLRaV-1, GLRaV-2, GLRaV-3, GLRaV-4, or GLRaV-7.

In some embodiments, the disease is induced by the virus GLRaV-3.

In some embodiments, preventing or treating the disease comprises contacting a plant or a part thereof with a nanoparticle of the invention or a composition comprising same, the nanoparticle comprising a polynucleotide molecule configured to hybridize and/or silence the expression of a nucleic acid molecule derived from the virus GLRaV-3.

In some embodiments, preventing or treating the disease comprises contacting a plant or a part thereof with a nanoparticle of the invention or a composition comprising same, the nanoparticle comprising a polynucleotide molecule configured to hybridize and/or silence the expression of a nucleic acid molecule encoding RdRp (SEQ ID NO: 13) derived from the virus GLRaV-3.

In some embodiments, preventing or treating the disease comprises contacting a plant or a part thereof with a nanoparticle of the invention or a composition comprising same, the nanoparticle comprising a polynucleotide molecule configured to hybridize and/or silence the expression of a nucleic acid molecule encoding CP (SEQ ID NO: 14) derived from the virus GLRaV-3.

In some embodiments, preventing or treating the disease comprises contacting a plant or a part thereof with a nanoparticle of the invention or a composition comprising same, the nanoparticle comprising a polynucleotide molecule configured to hybridize and/or silence the expression of a nucleic acid molecule encoding p19.7 RNA silencing suppressor derived from the virus GLRaV-3.

In some embodiments, p.19.7 silencing repressor is encoded by a nucleic acid comprising or consisting of the sequence:

(SEQ ID NO: 15)
ATGGACCTATCGTTTATTATTGTGCAGATCCTTTCCGCCT
CGTACAATAATGACGTGACAGCACTTTACACTTTGATTAA
CGCGTATAATAGCGTTGATGATACGACGCGCTGGGCAGCG
ATAAACGATCCGCAAGCTGAGGTTAACGTCGTGAAGGCTT
ACGTAGCTACTACAGCGACGACTGAGCTGCATAGAACAAT
TCTCATTGACAGTATAGACTCCGCCTTCGCTTATGACCAA
GTGGGGTGTTTGGTGGGCATAGCTAGAGGTTTGCTTAGAC
ATTCGGAAGATGTTCTGGAGGTCATCAAGTCGATGGAGTT
ATTCGAAGTGTGTCGTGGAAAGAGGGGAAGCAAAAGATAT
CTTGGATACTTAAGTGATCAATGCACTAACAAATACATGA
TGCTAACTCAGGCCGGACTGGCCGCAGTTGAAGGAGCAGA
CATACTACGAACGAATCATCTAGTCAGTGGTAATAAGTTC
TCTCCAAATTTCGGGATCGCTAGGATGTTGCTCTTGACGC
TTTGTTGCGGAGCACTATAA.

In some embodiments, preventing or treating comprises reducing: a titer of a virus in the circulation of a plant or a part thereof, in a cell of a plant, or a combination thereof, the number of viral particles in a the circulation of a plant or a part thereof, in a cell of a plant, or a combination thereof, the number and/or stability of RNA molecules encoding a viral peptide, such as, but not limited to RdRp, CP, or both, the expression levels of RNA molecules encoding a viral peptide, such as, but not limited to RdRp, CP, or both, in the circulation of a plant or a part thereof, in a cell of a plant, or a combination thereof, the amount of a viral peptide, such as, but not limited to RdRp, CP, or both, in the circulation of a plant or a part thereof, in a cell of a plant, or a combination thereof.

In some embodiments, preventing or treating comprises reducing the survival of a pathogen. In some embodiments, preventing or treating comprises reducing the replication rate of a pathogen. In some embodiments, preventing or treating comprises reducing the tolerability of a pathogen to standard therapy and/or prophylactics. In some embodiments, preventing or treating comprises increasing the susceptibility and/or vulnerability of a pathogen to standard therapy and/or prophylactics.

In some embodiments, preventing or treating comprises reducing: number of curled leaves of a plant, rate of downward curling or cupping of leaves of a plant, or any combination thereof.

Methods for determining a plant is afflicted with GLD are common and would be apparent to one of ordinary skill in the art.

In some embodiments, contacting comprises spraying the plant or a part thereof. In some embodiments, contacting comprises spraying in a vicinity of a plant or a part thereof. In some embodiments, contacting comprises spraying a growth medium comprising a plant. In some embodiments a growth medium comprise soil.

In some embodiments, vicinity is at a distance of 10 cm to 50 cm, 1 cm to 100 cm, 10 cm to 1 m, 0.5 m to 2.5 m, 1 m to 50 m, 0.1 m to 30 m. each possibility represents a separate embodiment of the invention.

In some embodiments, a plant part comprises at least one leaf of the plant. In some embodiments, a plant part comprises one or more leaves of the plant. In some embodiments, a plant part comprises at least a portion of the foliage of the plant. In some embodiments, a plant part comprises the foliage of the plant.

As used herein, the terms “treatment” or “treating” of a disease, disorder or condition encompasses alleviation of at least one symptom thereof, a reduction in the severity thereof, or inhibition of the progression thereof. Treatment need not mean that the disease, disorder, or condition is totally cured. To be an effective treatment, a useful composition herein needs only to reduce the severity of a disease, disorder, or condition, reduce the severity of symptoms associated therewith, or provide improvement to a patient or subject's quality of life. In some embodiments, alleviated symptoms of the disease, disorder or condition.

As used herein, the term “prevention” of a disease, disorder, or condition encompasses the delay, prevention, suppression, or inhibition of the onset of a disease, disorder, or condition. As used in accordance with the presently described subject matter, the term “prevention” relates to a process of prophylaxis in which a subject is exposed to the presently described compositions or composition prior to the induction or onset of the disease/disorder process. The term “suppression” is used to describe a condition wherein the disease/disorder process has already begun but obvious symptoms of the condition have yet to be realized. Thus, the cells of an individual may have the disease/disorder, but no outside signs of the disease/disorder have yet been clinically recognized. In either case, the term prophylaxis can be applied to encompass both prevention and suppression. Conversely, the term “treatment” refers to the clinical application of active agents to combat an already existing condition whose clinical presentation has already been realized in a patient.

As used herein, “treating” comprises ameliorating and/or preventing.

In some embodiments, ameliorating comprises alleviating at least one symptom associated with a disease as described herein.

### General

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

As used herein, the term “about” when combined with a value refers to plus and minus 10% of the reference value. For example, a length of about 1,000 nanometers (nm) refers to a length of 1,000 nm±100 nm.

It is noted that as used herein and in the appended claims, the singular forms “a”, “an”, and “the” include plural referents unless the context clearly dictates otherwise. Thus, for example, reference to “a polynucleotide” includes a plurality of such polynucleotides and reference to “the polypeptide” includes reference to one or more polypeptides and equivalents thereof known to those skilled in the art, and so forth. It is further noted that the claims may be drafted to exclude any optional element. As such, this statement is intended to serve as antecedent basis for use of such exclusive terminology as “solely”, “only” and the like in connection with the recitation of claim elements or use of a “negative” limitation.

In those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B”.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. All combinations of the embodiments pertaining to the invention are specifically embraced by the present invention and are disclosed herein just as if each and every combination was individually and explicitly disclosed. In addition, all sub-combinations of the various embodiments and elements thereof are also specifically embraced by the present invention and are disclosed herein just as if each and every such sub-combination was individually and explicitly disclosed herein.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

Various embodiments and aspects of the present invention as delineated hereinabove and as claimed in the claims section below find experimental support in the following examples.

### EXAMPLES

Generally, the nomenclature used herein, and the laboratory procedures utilized in the present invention include molecular, biochemical, microbiological and recombinant DNA techniques. Such techniques are thoroughly explained in the literature. See, for example, “Molecular Cloning: A laboratory Manual” Sambrook et al., (1989); “Current Protocols in Molecular Biology” Volumes I-III Ausubel, R. M., ed. (1994); Ausubel et al., “Current Protocols in Molecular Biology”, John Wiley and Sons, Baltimore, Maryland (1989); Perbal, “A Practical Guide to Molecular Cloning”, John Wiley & Sons, New York (1988); Watson et al., “Recombinant DNA”, Scientific American Books, New York; Birren et al. (eds) “Genome Analysis: A Laboratory Manual Series”, Vols. 1-4, Cold Spring Harbor Laboratory Press, New York (1998); methodologies as set forth in U.S. Pat. Nos. 4,666,828; 4,683,202; 4,801,531; 5,192,659 and 5,272,057; “Cell Biology: A Laboratory Handbook”, Volumes I-III Cellis, J. E., ed. (1994); “Culture of Animal Cells—A Manual of Basic Technique” by Freshney, Wiley-Liss, N. Y. (1994), Third Edition; “Current Protocols in Immunology” Volumes I-III Coligan J. E., ed. (1994); Stites et al. (eds), “Basic and Clinical Immunology” (8^{th} Edition), Appleton & Lange, Norwalk, C T (1994); Mishell and Shiigi (eds), “Strategies for Protein Purification and Characterization—A Laboratory Course Manual” CSHL Press (1996); all of which are incorporated by reference. Other general references are provided throughout this document.

### Materials and Methods

### Synthesis of Modified Branched Polyethylenimine

Branched Polyethylenimine (Mw=800 gr/mol, Sigma-Aldrich—Merck) was conjugated with 1,2-Epoxytetradecane (Tokyo chemical industry co.) to formulate 14 carbon lipid-conjugated branched PEI. Conjugation was conducted through an epoxide ring opening reaction, maintaining a 3:1 molar ratio (Epoxide:bPEI) mixture. Briefly, 4.75 gr of bPEI were dissolved in 150 mL of pure ethanol and heated to reach homogenous solution. Next, pre-calculated epoxide volume was added to the solution while keeping vigorous mixing. Mixture was incubated for 4 hours while maintaining constant heating (90° C.) and mixing (600 rpm) using a thermocouple. After reaction was completed, verification of successful reaction was performed by loading 2 μl of 20-fold diluted reaction product on a silica-coated thin-layer chromatography plate (Biotage) with Chloroform:n-Hexane volume per volume (v/v) ratio of 1:1, as the mobile phase.

dsRNA-lmPEI Complexation

Complexation based on electrostatic interaction between dsRNA and lmPEI was conducted by applying ethanol injection technique. N:P ration is defined as the ration between positively charged amine groups to negatively charged phosphate groups and plays an important role in complexation calculations. In general, pre-heated dsRNA and lmPEI were added to 25 mM sodium acetate buffer (pH=5.2) in 1:1 v/v ratio, keeping a 2:1 N:P molar ratio. lmPEI injection occurred while mixing solution vigorously. Subsequently, mixture was incubated in an Eppendorf shaker for 20 minutes at 40° C. and 1,000 rpm. Nanoparticles' characteristics, such as size distribution, stability and mean diameter, and charge were further determined at room temperature by dynamic light scattering using Nano ZSP (Malvern, United Kingdom).

dsRNA Retention and Release

Evaluation of dsRNA complexation together with its release was assessed using Heparin release assay. Heparin is a strong negatively charged molecule that can compete with dsRNA for electrostatic interactions, thus, releasing it from NPs. Following NPs formation, 1 μl of diluted Heparin sodium salt from porcine intestinal mucosa (Sigma-Aldrich) was added to approximately 250 ng of complexed dsRNA and incubated for 20 minutes at 35° C. Subsequently, 2% gel agarose (Hy-Labs) in TAE (×1) with Ethidium Bromide (Hy-labs) was visualized under UV light after 35-minute run at 100 V.

### Rnase Assay

Nanoparticle ability to protect dsRNA from degradation was examined using Rnase A (Thermo-Scientific, Cat. EN0531) and RiboLock Rnase Inhibitor (Thermo-Scientific, Cat. E00381). Briefly, 20 μl of dsRNA-lmPEI NPs (approximately 700 ng dsRNA) were incubated with 2 ng Rnase A for 2 hours at 37° C. following enzyme inactivation through incubation with RiboLock Rnase Inhibitor (20 units per 70 ng of complexed dsRNA) for 1 hour at 37° C. Next, solution was incubated for another 20 minutes at 37° C. with diluted Heparin to release dsRNA from NPs. Solution was applied with adequate controls to a 2% agarose gel electrophoresis for 35 minutes at 100 V.

### Cryo-TEM Imaging and Fast Fourier Transformation Analysis

Cryogenic transmission electron microscopy (cryo-TEM) imaging was performed at the Technion Center for Electron Microscopy of Soft Matter (TCEMSM) on a Thermo-Fisher Talos F200C, FEG-equipped high resolution-TEM, operated at 200 kV. Specimens were transferred into a Gatan 626.6 cryo-holder and equilibrated below −170° C. Micrographs were recorded by a Thermo-Fisher Falcon III direct detector camera, at a 4k×4k resolution. Specimens were examined at TEM nanoprobe mode using volta phase plates for contrast enhancement. Imaging was performed at a low dose mode of work to minimize the exposure of the imaged area to electrons. Images were acquired using the TEM Imaging and Acquisition (TIA) software. Inter-fiber spacing was deduced by performing radial integration on FFT of the relevant obtained images. Integration was done using FIJI software plugin by Paul Baggethun, 2009 version.

### Cy5-lmPEI Labeling

In order to visualize NPs under microscopy instrumentation, amine-reactive red emitting fluorescent dye Cyanine5 NHS ester (Ex/Em: 646/662, Abcam) was conjugated to lmPEI prior dsRNA complexation through carbodiimide reaction using NHS as a coupling reagent. After the epoxide ring opening reaction, that was described previously, the Cy5 NHS ester and lmPEI were reacted in 1:4 (Cy5:NH2) molar ratio and incubated for 90 minutes at 37° C., and 600 rpm to yield Cy5-lmPEI. One step size exclusion procedure was held using G-10 Sephadex beads (Sigma Aldrich) to isolate desired product from raw reactants and other byproducts. Each step of the process was verified using thin layer chromatography (TLC) with Chloroform:Methanol 1:1 v/v as the mobile phase.

### Fluorescent Microscopy

To investigate nanoparticle uptake by vine leaves following spray and immersion administration routes, Cy5-labeled dsRNA-lmPEI were synthesized and complexed as described above. In addition, free Cy5 was treated the same as labeled NPs to be administered as control. Vine leaves were divided into five treatment groups (N=5 per group) as follows: (i) 25 mM sodium acetate buffer (pH—5.2), (ii) sprayed NPs, (iii) spray control, (iv) immersion NPs, and (v) immersion control. Immersion leaves' petioles were embedded into 600 μl of infiltrate treatment, whereas sprayed leaves were sprayed with treatment to reach seepage (˜10 mL). Each group was imaged at different time points (0, 20, 50, and 120 minutes) and six different locations were chosen within each leaf to best average total image signal. Samples were exposed for 400 ms and images were obtained using Olympus SZX16 fluorescent binocular equipped with DP72 CCD camera combined with ×1.6 0.3 NA objective lens and Olympus mCherry filter (Excitation: 542-582, Emission: 603-678). Nanoparticle Biodistribution

To prove NP distribution within vines, a rare earth metal, EuCl3 (12-20 ppm) was encapsulated within 95±25 nm sized liposomes and vine leaves were embedded into infiltrate solution for a 72 hour period. Leaves were taken from treated and untreated vines at different distances from application point and dehydrated in an oven (BIFA Electro-therm MS8 multi stage laboratory furnace, Middlesex, UK) for 2 hours at 105° C. Dry matter was weighted and cremated for 5 hours at 550° C. Ash samples were dissolved in 1% HNO3, collected into 10 mL tubes, filtered (0.45 pm filter) and analyzed for Europium presence by ICP-OES apparatus, using pre-prepared calibration curve obtained with Eu ICP standard (Sigma Aldrich).

RNA Extraction and cDNA Production

Random shoots were pruned, leaves were disposed, and periderm was peeled off using a scalpel exposing inner tissues. Next, xylem was peeled out retaining the green phloem immediately transferred to −80° C. A hundred and fifty (150) mg of frozen phloem were crushed to a powder-like material in liquid nitrogen using mortar and pestle. Nine hundred (900) μl of Cetyltrimethylammonium bromide (CTAB—Sigma Aldrich—Merck) mixture were heated to 65° C., and β-mercaptoethanol was added to a final concentration of 2%. The mix was added to the crushed shoots and soaked in a bath at 65° C. for 10 minutes. Additional 900 μl of chloroform:isoamyl alcohol (24:1) (Sigma-Aldrich—Merck) was added to the tube and mixed vigorously by hand. The tubes were centrifuged at 11,000 g for 10 minutes at 4° C. The upper layer was collected from the tubes. This step was repeated once, and Chloroform:isoamyl alcohol (24:1) was added and the upper layer collected. One third (⅓) of the mixture volume of LiCl 10 M was added and incubated on ice for 30 minutes, to let the RNA precipitate. After precipitation, the tubes were centrifuged at 21,000 g for 20 minutes at 4° C., the supernatant discarded. One (1) ml of SSTE buffer, preheated to 65° C., was added to the tubes, followed by strong vortexing. Additional 1 ml of phenol:chloroform:isoamyl alcohol (25:24:1) (Sigma-Aldrich—Merck) was added and the tubes were centrifuged at 11,000 g for 10 minutes at 4° C. The upper layer was then collected into a new tube, and the volume was measured. The RNA was then precipitated by adding a 0.7-equivalent volume of ice-cold isopropanol and the tubes were inverted and immediately centrifuged at 21,000 g for 15 minutes at 4° C. The isopropanol was removed, and the pellet was washed with 300 μl of 70% cold ethanol and centrifuged again at 21,000 g for 3 minutes. All the ethanol was removed using a loading tip and the tubes were left open on ice for 30 minutes to evaporate residual ethanol. The pellet was resuspended in 30 μl of Diethylpyrocarbonate (DEPC, Sigma-Aldrich—Merck)-treated ddH2O. After RNA was extracted from the shoots, total cDNA was generated, using Maxima First Strand cDNA Synthesis Kit for RT-qPCR (Thermo Fisher Ltd), following the manufacturer's protocol.

### GLRaV Identification

cDNA was amplified using specific primers (see Table 2 below) for various GLRaV strains by polymerase chain reaction (PCR). 2×PCRBIO Taq Mix Red (PCRBIOSYSTEMS) PCR kit was used. PCR products were sent to HyLabs IL Ltd for Sanger sequencing, without further purification.

TABLE 2
Forward and revers primers for
GLRaV strains identification

| | | SEQ |
|---|---|---|
| Primer | | ID |
| Name | Sequence 5′ -> 3′ | NO: |
| GLRAV-1_F | CTAGCGTTATATCTCAAAAT | 1 |
| | GA | |
| GLRAV-1_R | CCCATCACTTCAGCACATAAA | 2 |
| GLRAV-2_F | TTGACAGCAGCCGATTAAGCG | 3 |
| GLRAV-2_R | CTGACATTATTGGTGCGACGG | 4 |
| GLRAV-3_F | CGCTAGGGCTGTGGAAGTATT | 5 |
| GLRAV-3_R | GTTGTCCCGGGTACCAGATAT | 6 |
| GLRAV-4_F | ACATTCTCCACCTTGTGCTTT | 7 |
| GLRAV-4_R | CATACAAGCGAGTGCAATTA | 8 |
| | CA | |
| GLRAV-7_F | TATATCCCAACGGAGATGGC | 9 |
| GLRAV-7_R | ATGTTCCTCCACCAAAATCG | 10 |
| GLRAV-9_F | CGGCATAAGAAAAGATGGCAC | 11 |
| GLRAV-9_R | TCATTCACCACTGCTTGAAC | 12 |

### Field Experiments

Field trials (2018-2019) were conducted at ‘Bravdo’ vineyard located near Carmi Yossef, Israel. Vines showed various symptoms consistent with GLRaV3 infection, from small red dots on leaves to leaves that are completely red and curled inwards. At the first experiment (June-September 2018), a total of 28 vines were selected and divided into seven treatment groups (N=4) as follows: (1) Untreated healthy vines; (2) Untreated infected vines; (3) Infected vines treated with 25 mM sodium acetate buffer; (4) Infected vines treated with lmPEI solution; (5) Infected vines treated with naked RdRp sequence; (6) Infected vines treated with RdRp-lmPEI NPs; and (7) Infected vines treated with both RdRp-lmPEI and CP-lmPEI NPs. To improve infiltrate's uptake, two administration methods were employed—(i) selected leaves were brushed with 5 mL of treatment solution, and (ii) trimmed shoots were embedded in 20 mL of treatment solution for 24-hour period. Shoots and berries were harvested for further analysis 6, 10, and 21 days post treatment, and 8, and 9 weeks post treatment, respectively. At the following year (June-September 2019), administration methods used were canopy spraying and shoot immersion. A total of 47 vines were distributed to construct the following treatment groups (N=10, except group number 4 where N=7): (1) Untreated healthy vines; (2) Untreated infected vines; (3) Healthy vines sprayed with lmPEI solution; (4) Infected vines' trimmed shoots immersed within both RdRp-lmPEI and CP-lmPEI NPs; and (5) Infected vines sprayed with both RdRp-lmPEI and CP-lmPEI NPs. Shoots were sampled every two weeks until harvest, whereas berry collection took place three times after veraison.

### Sequences Design

RNA dependent RNA Polymerase (RdRp) sequence design included the following nucleic acid sequence:

(SEQ ID NO: 13)
GGTAGCGGTGATGATAGCCTTATATTTAGTCGGCAGCCGT
TGGATATTGATACGTCGGTTCTGAGCGATAATTTTGGTTT
TGACGTAAAGATTTTTAACCAAGCTGCTCCATATTTTTGT
TCTAAGTTTTTAGTTCAAGTCGAGGATAGTCTCTTTTTTG
TTCCCCGATCCACTTAAACTCTTCGTTAAGTTTGGAGCTT
CCAAAACTTCAGATATCGACCTTTTACATGAGATTTTTCA
ATCTTTCGTCG.

Coat protein (CP) sequence design included the following nucleic acid sequence:

(SEQ ID NO: 14)
CCAGCGCAAGTGGCGGAACCACAGGAAACCGATATAGGGT
AGTGCCGGAATCTGAGACTCTCACACCAAATAAGTTGGTT
TTCGAGAAAGATCCAGACAAGTTCTTGAAGACTATGGGCA
AGGGAATAGCTTTGGACTTGGCGGGAGTTACCCACAAACC
GAAAGTTATTAACGAGCCAGGGAAAGTATCAGTAGAGGTG
GCAATGAAGATTAATGCCGCATTGATGGAGCTGTGTAAGA
AGGTTATGG.

### Viral Titer Assessment

Using primers specific to conserved RNA dependent RNA polymerase and Hsp70 like protein sequences of GLRaV-3 (shown below), real-time RT-PCR was performed using Power SYBR™ Green PCR Master Mix (Thermo Fisher Ltd, Applied Biosystems™) and qPCR BIO SyGreen Mix (PCRBIOSYSTEMS) implemented according to manufacturer's instructions in a Corbett Rotor-Gene™ 6000 PCR machine. Specific primers used are as follows:

| | | SEQ |
|---|---|---|
| | | ID |
| Primer Name | Sequence 5′ -> 3′ | NO: |
| RNA dependent | AGTACGTAACGGGGCAGAAT | 16 |
| RNA polymerase_F | | |
| RNA dependent | ACCTGCTTCATGAGAGCACT | 17 |
| RNA polymerase | | |
| Hsp70-like | AAGTGCTCTAGTTAAGGTCA | 18 |
| protein_F | GGAGTGA | |
| Hsp70-like | GTATTGGACTACCTTTCGGG | 19 |
| protein_R | AAAAT | |
| Grapevine actin_F | TCCTCTGGACAATGGATGGA | 20 |
| Grapevine actin_R | CTTGCATCCCTCAGCACCTT | 21 |

### Grape Quality Parameters

Berries were tested for brix (sugar) levels, weight, pH levels, color density, tannin index, and softness ratio. Berries were weighed, and the number of berries needed to reach 132 grams (to calculate the average berry weight) was counted. Pure ethanol was added, and the berries were crushed. Mixture was filtered using a strainer to measure brix. For acidity measurement, 10 mL of the same mixture were taken and tittered using 0.1 N NaOH until pH reached 8.15. The volume of NaOH needed was used to calculated total acid content as follows: 0.75×NaOH volume. Tartaric acid correction was done to mimic wine's natural acidity level. After 48 hours precipitation, color density, tannin index, and softness ratio were measured as showed below. Mixture was centrifuged at 1,500 rpm for 10 minutes and diluted 25-fold. Supernatant's optical density (OD) was measured using a spectrophotometer at 520 nm and 420 nm. Color density was calculated as follow: (25×OD420 nm)+(25×OD520 nm). To measure tannin index (total phenols), mixture was diluted 100-fold, then measured using spectrophotometer at 280 nm. Tannin index was calculated as follows: 100×OD280 nm. Lastly, softness ratio was calculated: Softness ratio=10×(Color density/Tannin index).

During the harvest of summer 2019, the total weight of the grapes harvested from each vine was measured as well.

### Statistical Analysis and Image Acquisition

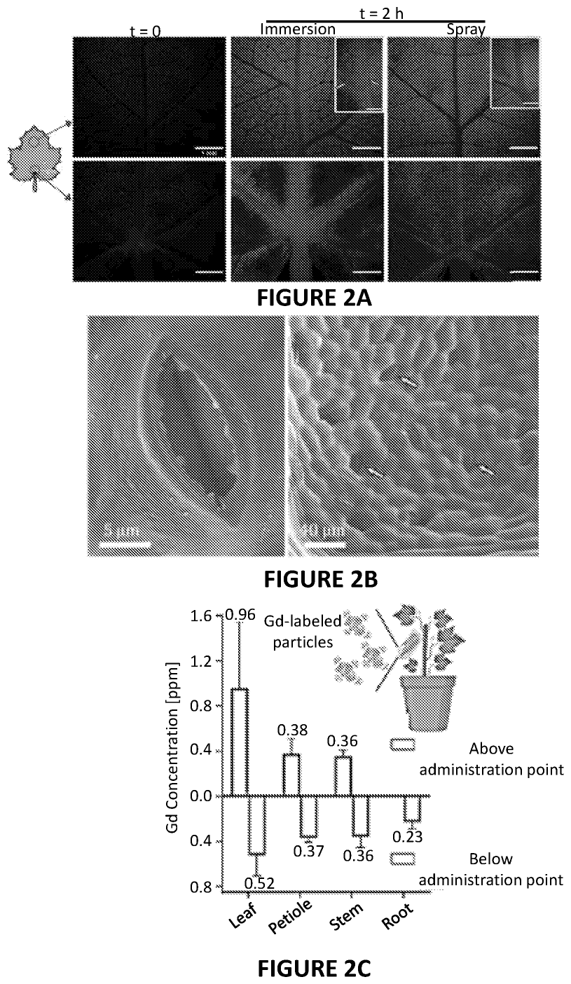

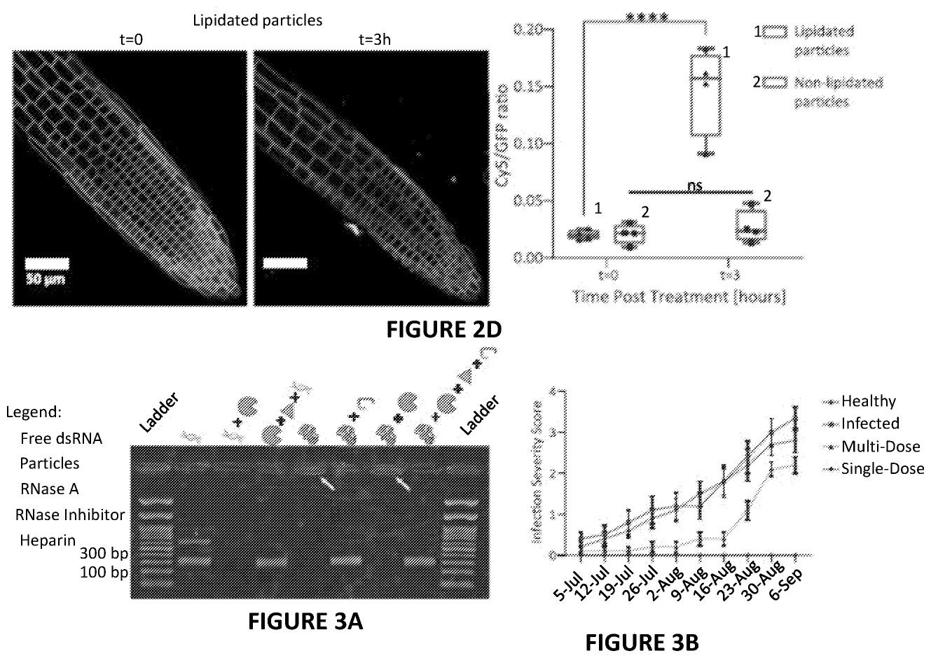

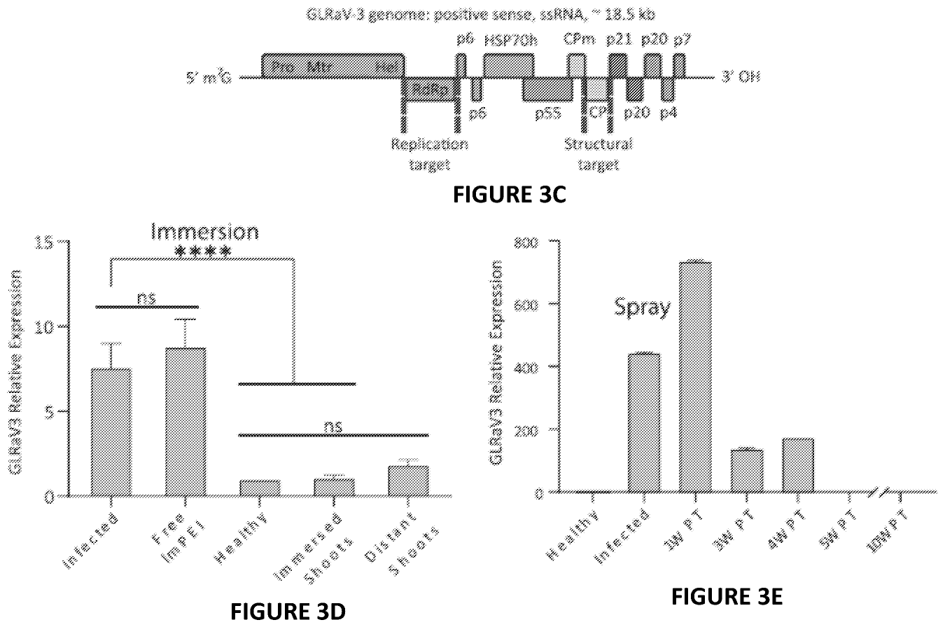

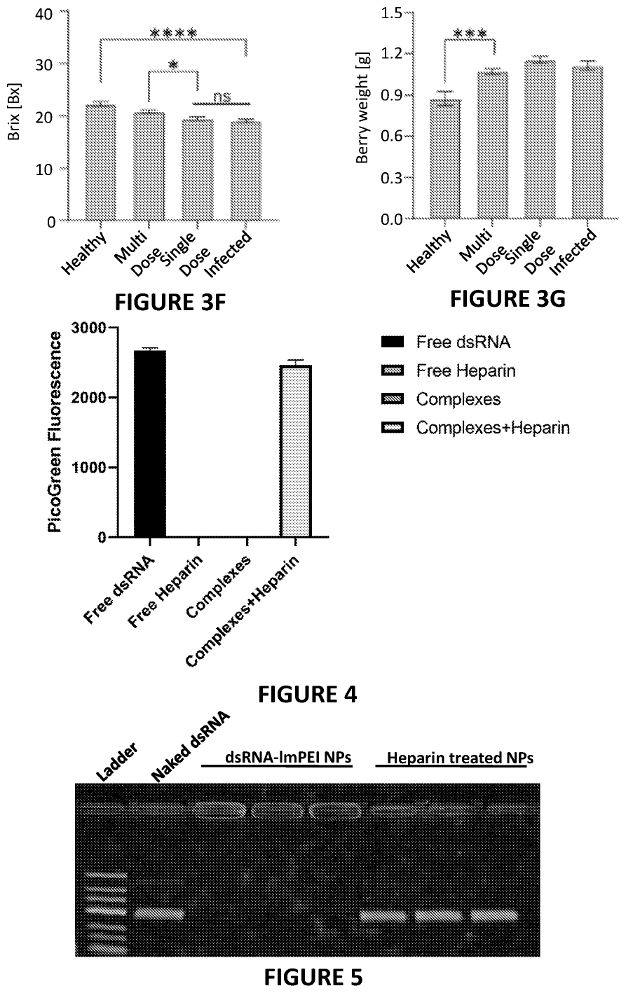

Data is presented as mean values and error bars indicate SD. Statistical studies such as two-tailed paired t-test in FIG. 2 and multiple comparison of one-way ANOVA in FIG. 3 were conducted using Prism software version 9.0. Gel and binocular images were processed using Fiji software. Particles were identified using Imaris 9.1.2 software (Oxford, Bitplane) spots module to detect spots as spherical objects with 0.2 μm diameter and quality threshold value above 3.

### Example 1

### Preparation and Characterization of dsRNA-lmPEI Particles

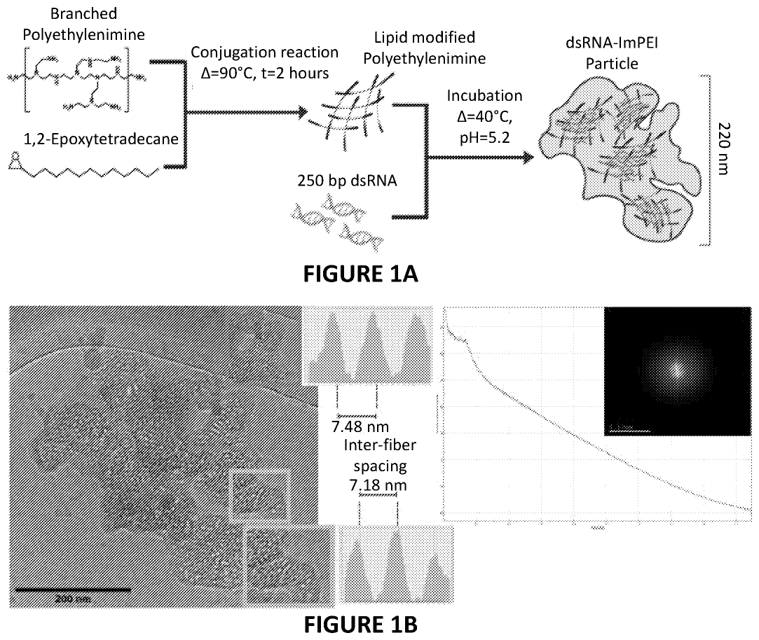

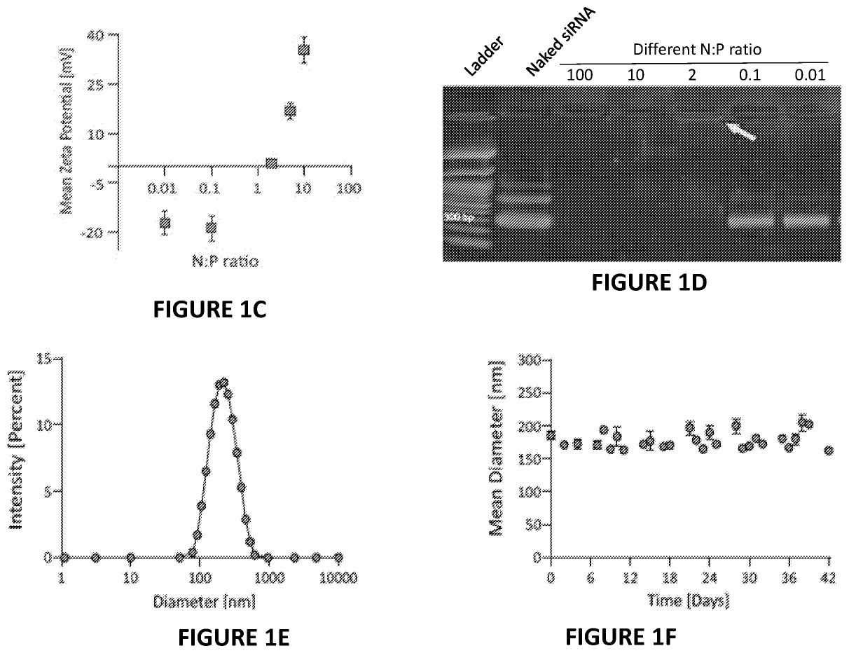

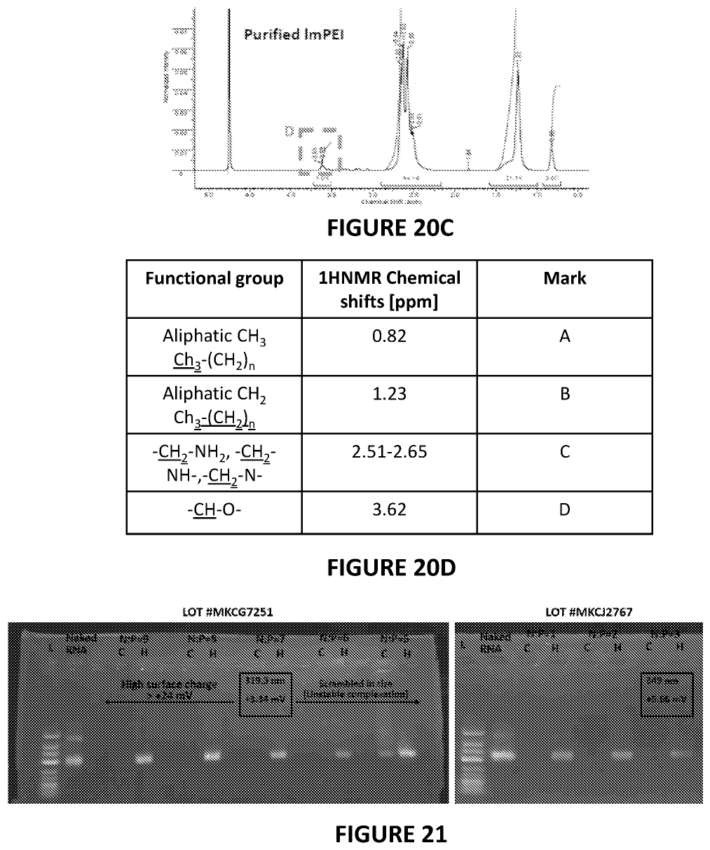

The inventors synthesized lmPEI as an RNA carrier and tested its effect on GLRaV-3 titer in grapevines. Briefly, 14-carbon lipid was conjugated to branch PEI in a 3:1 (epoxide tail:PEI head group) molar ratio to form lmPEI. The product was purified using multiple phase separation steps, and 1HNMR spectra revealed a peak at 3.62 ppm corresponding to a hydroxyl functional group that confirms the successful conjugation of lipids tails to the PEI (FIG. 20). Next, 250 bp dsRNA was complexed with lmPEI under acidic conditions (pH=5.2) to establish electrostatic interactions between the negatively charged dsRNA and cationic lmPEI, to formulate dsRNA-lmPEI particles, as illustrated in FIG. 1A. To target GLRaV-3's ability to replicate and assemble, we chose to knockdown RNA dependent RNA polymerase and coat protein genes using two conserved sequences (SEQ ID Nos.: 13 and 14, respectively). The sequence design excluded unintended off-targets within the GLRaV-3 and wine grapevine (e.g., Vitis vinifera) genomes. The dsRNA length was optimized to trigger the dicer-like protein at different locations along the sequence to generate multiple siRNAs and increase knockdown probability.

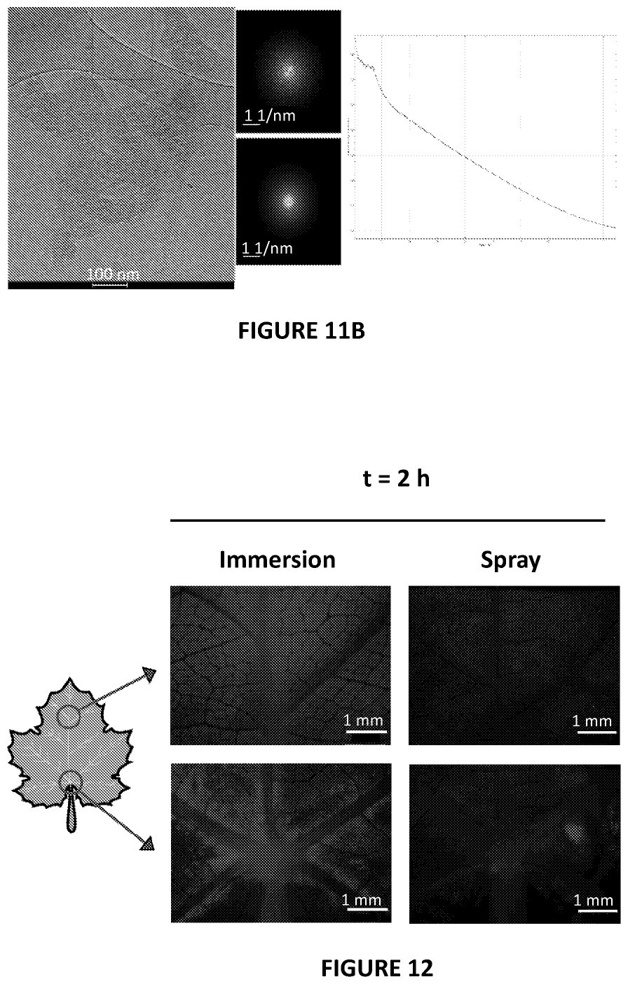

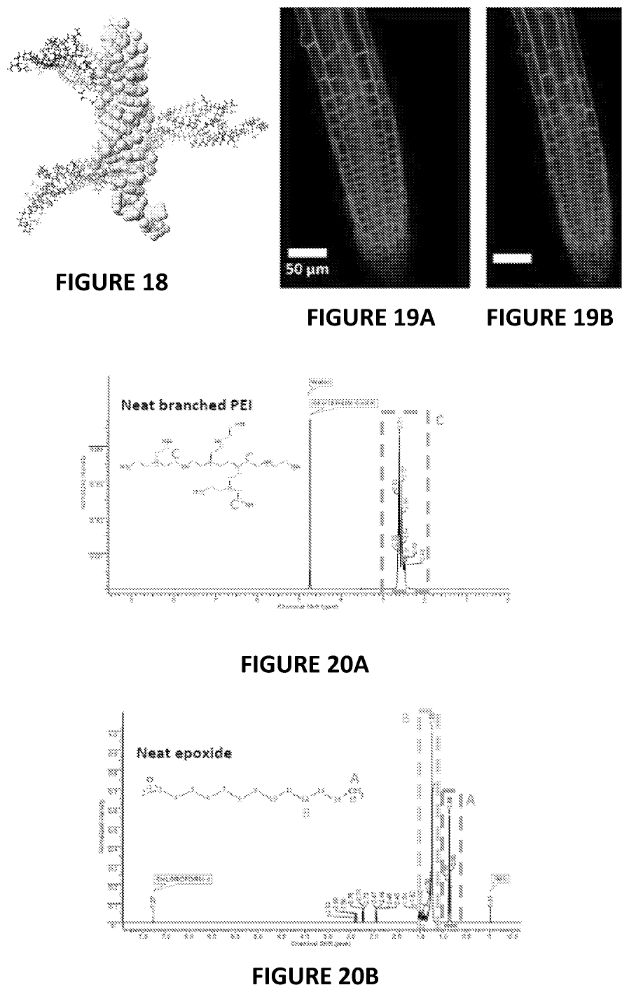

To be effective, the dsRNA-lmPEI particle must bind, protect, and release the RNA at the target site. Since binding and release rely on lmPEI electrostatic affinity to dsRNA, they can be controlled through the N:P ratio. In the current study, the N:P ratio is defined as the molar ratio between positively charged amine groups present in lmPEI and negatively charged phosphate groups present on the dsRNA backbone. To determine this ratio, a constant weight of dsRNA was converted to its equivalent phosphate mole and lmPEI was conjugated accordingly to reach the desired mole of protonated amines. Increasing the N:P ratio elevated the particle's surface charge (FIG. 1C), while below an N:P ratio of 2 (i.e., 0.01 and 0.1), particles were not formed, indicating insufficient lmPEI to bind dsRNA (FIG. 1D). Therefore, the inventors conducted the next experiments using N:P=2 particles which bind dsRNA, carrying a weak positive charge (0.91±0.08 mV). The encapsulation efficiency of dsRNA was 92% (FIG. 4) and the particle size averaged 220 nm (FIG. 1E) with 85% of particles in the range 150-450 nm. The dsRNA-lmPEI particles were imaged using cryo-TEM. Low and high contrast patterns indicate fibrillar high contrast aggregated structure. Some domains exhibited local order within the particle. The high contrast features correspond to sp2 carbons of the π-stacked system representing dsRNA and the low contrast represents sp3 hybridized atoms of the lmPEI, respectively. Relevant radial integration of fast Fourier transform (FFT) of the imaged particle was employed in the investigation of the inner structure of the particles (FIG. 1B). Previous studies have shown that DNA/PEI complexation is highly kinetic. This is due to electrostatic forces, the main driving force for binding, being affected by the percentage of protonated groups within PEI. Interfiber spacing between one dsRNA center of mass to another was 7.3±2 nm, as observed from the FFT and from the gray values profile measurements (see insets in FIG. 1B; additional measurements are found in FIG. 11). This spacing seems to be due to the lipid tails presence within the particle and their protrusion out from the polymeric backbone enabling possible interaction with other lmPEI molecules attached to other parts of the dsRNA fiber. The lipophilic character of the alkylic chains of the lmPEI also contributes to the aggregate formation in the aquatic environment as observed in the cryo-TEM image and from partially energy minimized molecular mechanics model (FIG. 18). Similar to the proposed model by Ziebarth and colleagues, the current findings may also show a possible model of lmPEI wrapping around dsRNA in a spiral manner. Finally, the inventors tested the particle size as a measure of stability and did not notice significant changes over a period of 40 days (FIG. 1F).

### Example 2

### Nanoparticle Biodistribution

The inventors evaluated the ability of dsRNA-lmPEI particles to be up taken and distribute within vines. lmPEI carrier was labeled with Cyanine 5 (Cy5) dye to be further complexed with dsRNA. Treatment groups (N=5 leaves per group) received five different treatments: (1) 25 mM sodium acetate buffer (control), Free Cy5—(2) spray and (3) immersion and Cy5 labeled particles—(4) spray and (5) immersion. Treatments were given for different time points after leaves were imaged under fluorescent binocular at six different locations and signal was quantified. Basal autofluorescence was seen at initial time and Cy5 signal was present in both spray and immersion administrations after 2-hour treatment as presented in FIG. 2A (control is presented in FIG. 12). Particles accumulation was visualized within leaf's primary and secondary veins when petiole was immersed within labeled particles in contrast to sprayed treatment. Moreover, quantification of signal over time arise in significant increase in average intensity and number of particles (P<0.05 and P<0.001, respectively) (FIG. 17). These results suggest particles can penetrate through stomata after spraying as well as enter and distribute within a leaf's veins following immersion, ultimately reaching the same outcome.

To quantify the biodistribution of the particles in the plant tissue, lmPEI particles were covalently conjugated to Gadolinium (GdCl3) using a DOTA chelator group. Then, Gd-labeled particles were administered to vine leaves by submersion for 72 h. Gd concentration was quantified in the plant tissues (leaves, petioles, stem, and roots) located up to 25 cm above or below the application point, using elemental analysis (FIG. 2C). Interestingly, Gd concentrations were similar above and below the application point, suggesting that the particles enter the leaf and translocate in the plant through the phloem vascular pathway. The phloem, a tissue mainly responsible for trafficking photosynthesis products from the leaves to the rest of the plant, is a primary harboring tissue of the GLRaV-3 virus in the vine. Overall, both qualitative microscopy and quantitative elemental analysis suggest that lmPEI-dsRNA particles distribute systemically within the vine.

The inventors further examined the effect of the lipid component on particle uptake into transgenic Arabidopsis roots expressing a plasma membrane-localized fusion protein GFP-LTI6b to mark the cell surface. Lipidated and non-lipidated PEI was complexed with RNA to form nanoparticles, which were then administered hydroponically to the roots before live imaging. The uptake of the particles was traced by covalently labeling the Cy5 dye to the PEI backbone, and then using confocal microscopy to image the roots over time. Treatment groups (N=4 per group) included five different treatments: 1) Cy5-labeled lipidated and 2) non-lipidated particles; 3) non-labeled lipidated and 4) non-lipidated particles and 5) free Cy5 (control). Roots were placed on an optical plate under a semi-permeable medium followed by an administration of a 20 μL treatment solution. Particles' accumulation was imaged and quantified at initial time and after 3 h (FIG. 2D, left and right panels, respectively). Accumulation dynamics showed that particles penetrated better through the elongation region rather than to meristematic zone thus creating a signal gradient from epidermis inwards. This observation may be attributed to low permeability of lateral root cap cells covering root tip (meristem). Particle uptake was quantified by measuring the Cy5 normalized to the plants' GFP signal over time. Lipidated particles showed a significant 7.35-fold increase in uptake (P<0.0001, FIG. 2D, right panel) compared to non-lipidated particles, that kept the same uptake ratio over 3 h (FIG. 19). This indicates that the lipid component in the RNA carrier plays a significant role in interacting with root epidermal tissue uptake.

To gain further knowledge regarding particle penetration pathways into the plant, lower (abaxial) and upper (adaxial) sides of an infected leaf were imaged via high resolution scanning electron microscopy (HR-SEM). Stomata are seen scattered throughout abaxial surface epidermal tissue (FIG. 2B). Size measurements of the stomate showed a 6.105 μm width and a 16.14 μm length opening, which can facilitate a port of entry for the nanoparticles. Apart from stomatal penetration, previous studies showed evidence of polar solute diffusion path across plant cuticle via “polar pores”. It was suggested that water molecules adsorb to polar groups presented on cuticular membrane (e.g., hydroxylic or ester groups), thus creating these pores. Since lipophilic compounds can diffuse the cuticle via interaction with lipophilic domains, it is possible that lapidated particles' entry may be facilitated by sorption to cuticular lipids. Taken together, although several foliar penetration pathways are known and excessive work is being done to gain insights regarding tissue and cellular uptake mechanism, it is still poorly understood how nanomaterials penetrate and translocate within plants.

### Example 3

### Loaded Sequence Stability and Release

To facilitate efficient knockdown, the RNA payload needs to be protected from degradation until reaching the target site. The inventors tested the ability of the lmPEI carrier to protect dsRNA from RNase-A (ribonuclease) degradation. More specifically, the inventors assessed the protection capacity of the complex against RNase-A before and after releasing the dsRNA from the particles and demonstrated that complexation with lmPEI protected the RNA from degradation (FIG. 3A). The inventors used heparin to release the RNA from the complex. Heparin is a highly negatively charged molecule that competes with dsRNA for electrostatic interactions, releasing the dsRNA from the lmPEI complex (FIG. 5). Protection from RNase degradation was similar for RdRp and CP sequences, suggesting that the particle protection against nuclease degradation is independent of the RNA sequence (FIG. 3C). In cells, it is suggested that the “proton sponge” effect is in charge of releasing the RNA from amine-based RNA carriers, such as lmPEI. In addition, the “proton sponge” effect was documented in mammalian cells to trigger the endosomal escape of nanoparticles and their payload to the cytoplasm. Plant cells contain a trans-Golgi network and multivesicular body similar to early and late endosomes, respectively. Endosomal pH, being the main parameter affecting cationic polymer buffering capacity, is similar in both mammalian (pH=6.3) and plant (pH=6.2) cells, thus suggesting the “proton sponge” effect may exist in both cell types.

### Example 4

### Field Experiments

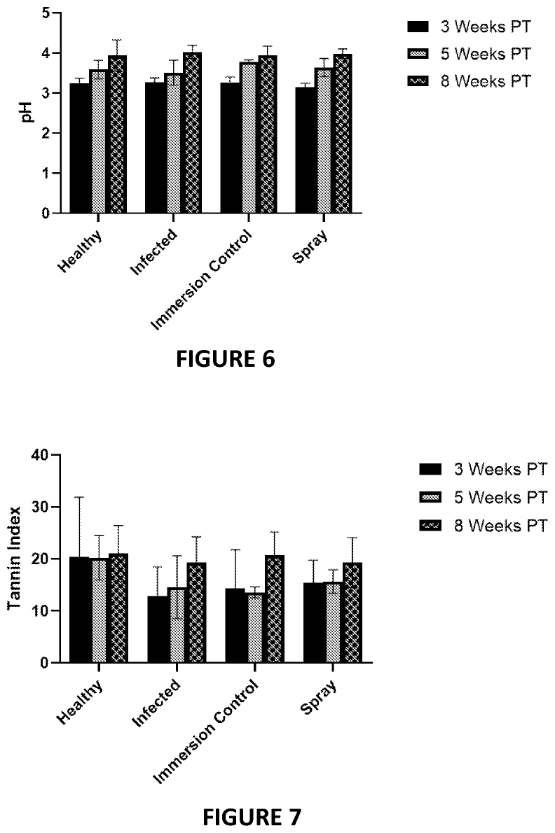

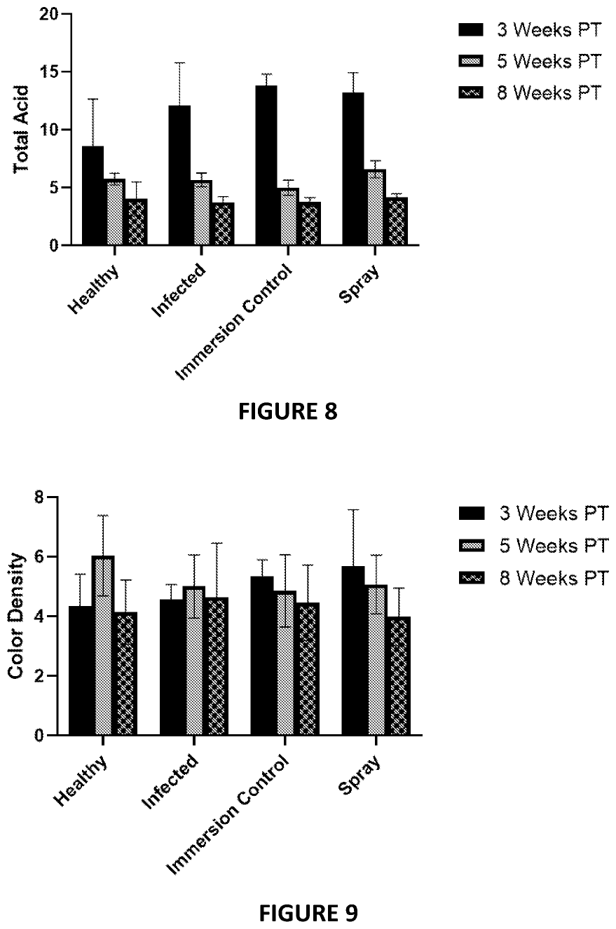

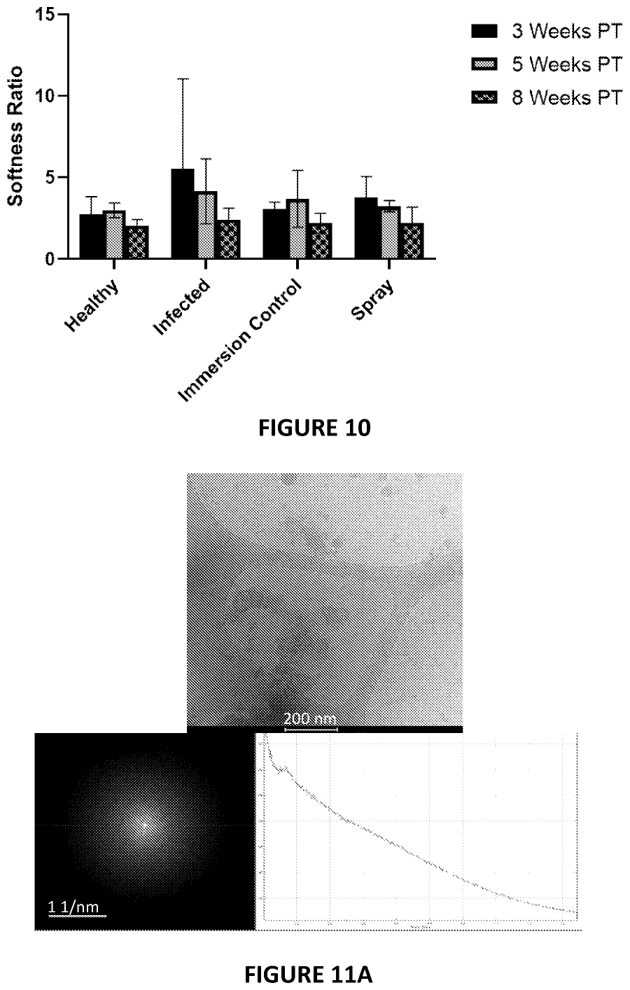

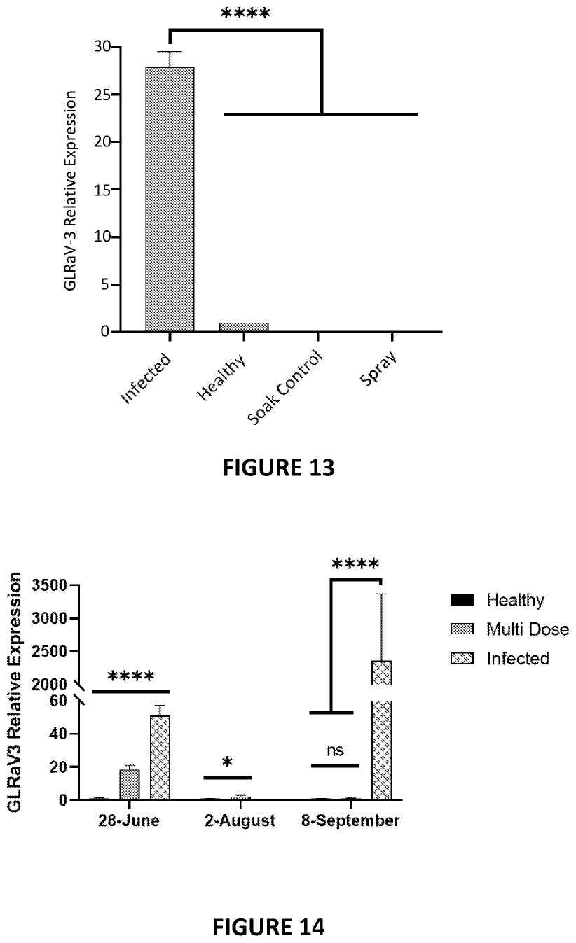

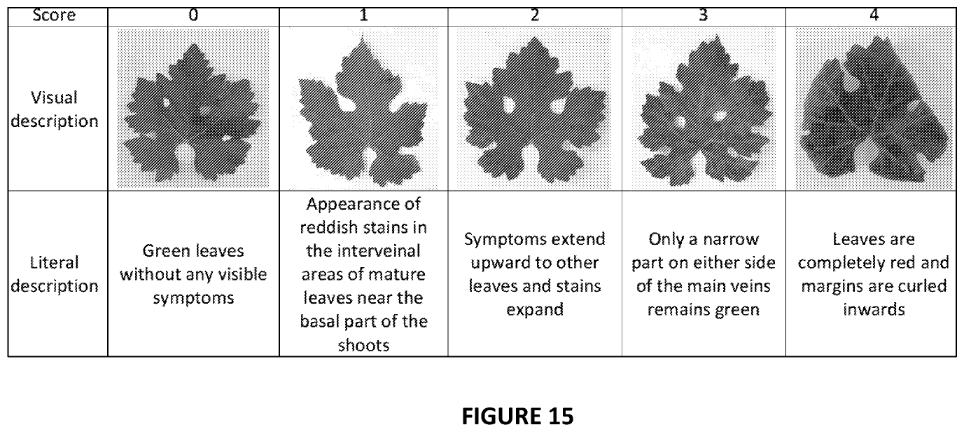

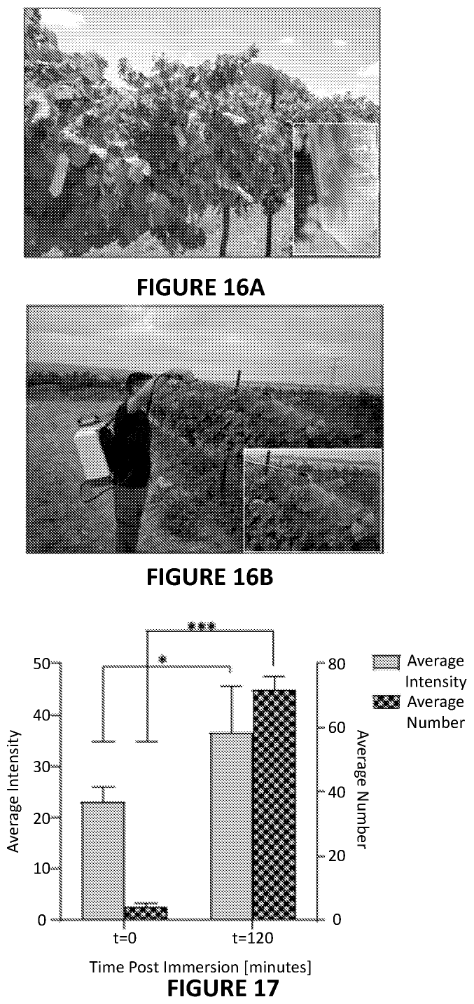

The inventors had examined the ability of dsRNA-lmPEI NPs to knockdown GLRaV-3 in infected vines. To achieve this objective, two field experiments (2018-2019) were conducted in a vineyard located in the Judean foothills in central Israel throughout the summer months (June-September) of each of the aforementioned years. Experiments took place in a Cabernet Sauvignon plot (31° 50′17″N, 34° 53′57″E, 140 meters above sea level) grafted upon Ruggeri rootstock planted in soil mainly composed of clay, sand, and silt. Vines were randomly divided into treatment groups by creating spaced blocks and those were spread across each row evenly. To follow GLD symptoms throughout the experiments, an infection severity assessment table (FIG. 15) was designed, and half of each treatment group was scored once a week. At the end of each experiment, shoots were pruned and analyzed by real time RT-PCR analysis to assess GLRaV-3 titer within phloem tissue. Additionally, after veraison and upon harvest, berries were tested for grape quality parameters. Essentially, two different administration methods were applied each year. In 2018 (N=28), to allow infiltrate uptake as much as possible, leaves were brushed with and shoots were cut and immersed in treatment infiltrate for 24 hours (FIG. 16A). In 2019, vines (N=47) were treated mainly by canopy spraying (FIG. 16B), and only a few by shoot immersion to serve as a control. In 2020, vines (N=80) were treated only by canopy spraying either with a single or multi dose (five treatments). In all consecutive years, there was a significant difference in GLRaV-3 titer between healthy and infected groups as well as between infected and NP-treated groups (P<0.05 for 2018, and P<0.0001 for 2019; FIGS. 3D-3E, and 13-14). These results imply dsRNA-lmPEI NPs penetrates and distributes within the vine, inducing viral knockdown. Moreover, knockdown dynamics show that three weeks after a single-dose administration the virus titer was decreased (FIG. 3E). In contrast to virus expression, GLD symptoms were delayed only when the vine was treated multiple times throughout the growing season (FIG. 3B). Berries' Brix and weight values at different time points post treatment of 2019 experiment are presented in FIGS. 3F and 3G respectively. Similarly, parameters such as pH, total acid, tannin index, color density, and softness ratio were tested (FIGS. 6-10). As ripening progresses, pH levels increase, acidity levels decrease, and as an overall tendency tannin index elevates. dsRNA-lmPEI administration did not harm grape quality parameters of any one of: healthy, infected, and treated vines. This suggests that a single application was sufficient to reduce the viral titer, but multiple applications may be needed to recover fruit quality.

### Example 5

### Physical-Chemical Characterization of the lm-PEI Nanoparticles

The inventors further characterized physical and chemical characteristics of the lm-PEI NP of the inventions.

When examining the effect of different N:P ratios on complexation and RNA release, the methods were as described hereinabove, with the exception of using a ratio of 2:1 which was obtained accordingly by adding adequate amounts of lmPEI to reach different N:P ratios.

Two branched Polyethyleneimine batches (LOT #MKCG7251 and #MKCJ2767) were used to synthesize lmPEI, as described herein.

The results show that ratios ranging between 2:1-7:1 are preferable for branched PEI (FIG. 21), rather than 1:1-9:1.

Further, the inventors have compared alkyl chains of varied lengths.

When examining the effect of different lipid lengths on particle uptake, the synthesis method is as described hereinabove, with the exception of altering 1,2-Epoxytetradecane (C14) to alkyl chains of: C10. C12, C16, and C18.

Confocal microscopy validated particle uptake into eGFP-trangenic Arabidopsis roots via steps as described herein.

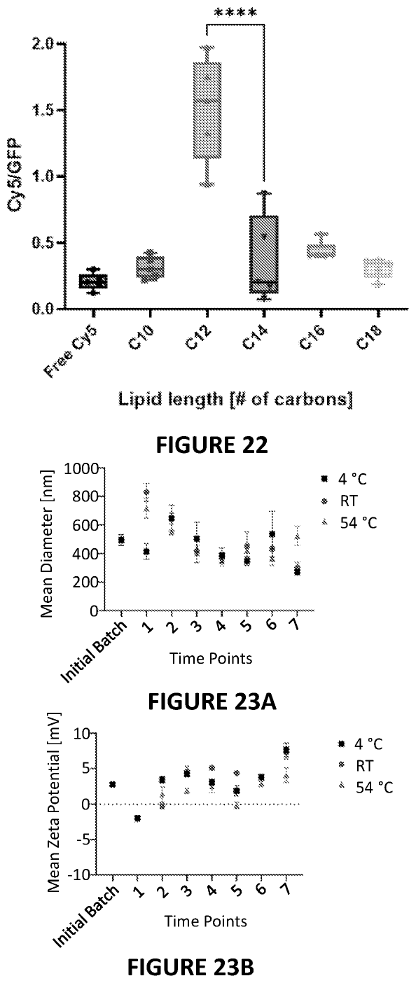

The results show that C12-lmPEI provided significantly higher uptake ratios into roots, compared to, for example, C14, C16, and C18 (FIG. 22).

The inventors further examined the stability of the lm-PEI NP of the invention over time and across different temperatures.

The inventors show that the lm-PEI NP of the invention are stable for a period of about 14 days in various temperatures, e.g., 4° C., room temp, and 54° C., as reflected by their mean diameter (FIG. 23A) and mean zeta potential (FIG. 23B).

The inventors have examined stability and complexation aspects of particles characterized by different N:P ratios. Specifically, when complexes were formed at N:P ratios lower than 2:1 (and specifically exemplified using 1:1 ratio), complexation occurred only partially. In this regard, only 80% of the dsRNA was actually integrated into the particles, whereas the remaining 20% was detected as naked dsRNA residues. This observation was further verified by analyzing complex sample using a Dynamic Light Scattering (DLS) device. Clearly, such particles are less favorable for use (˜20% loss of the active ingredient even prior to application).

In sharp contrast, when complexes were formed at higher N:P ratios, such as 7:1, strong electrostatic interactions prevented a full release of dsRNA (the active functional molecule/ingredient) from the complexes. This observation was obtained using a gel electrophoresis image and further supported by Zeta potential measurements showing high (+40 mV) surface charge values. Such N:P ratio rage (2:1 to 7:1) is important and advantageous so as to obtain a particle having increased carrying capacity and stability, that are required for subsequent applications.

To conclude, the herein disclosed findings show that dsRNA-lmPEI NPs are stable entities able to carry, protect and distribute within grapevines' transportation system, therefore providing a potent delivery system for long dsRNA. Although known for several decades, GLRaV-3 continues to infect and damage new vineyards with no proper solution in sight. The herein disclosed study proposes dsRNA-lmPEI NPs as a biological contender to solve this problem by inducing GLRaV-3 knockdown in infected vines following foliar application. These findings may also be leveraged for a broader platform to introduce any polynucleotide to a plant cell, such as to modify endogenous gene expression, treat viral infections in any plant, or to replace pest control as we know it today.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

1. A nanoparticle comprising:
a. an amphiphilic co-polymer comprising an ionizable polymer covalently bound to a hydrophobic domain; and
b. a polynucleotide comprising 60 to 500 nucleobases;
wherein said ionizable polymer comprises an amine group; wherein a nitrogen to phosphate (N:P) molar ratio within said nanoparticle ranges from 2:1 to 7:1, wherein said polynucleotide is non-covalently bound to said ionizable polymer, and wherein said hydrophobic domain comprises an alkyl chain having a length sufficient to stabilize said nanoparticle in an aqueous solution for a time period of at least 1 hour.

2. The nanoparticle of claim 1, wherein said alkyl chain comprises between 10 and 14 carbon atoms, and optionally wherein said nanoparticle having a particle size between 100 nm and 500 nm.

3. (canceled)

4. The nanoparticle of claim 1, having a particle size between 150 nm and 350 nm.

5. The nanoparticle of claim 1, wherein said amine group is any one of a primary amine group, a secondary amine group, a tertiary amine group, or any combination thereof.

6. The nanoparticle of claim 1, wherein said ionizable polymer is polyethyleneimine (PEI), and optionally wherein any one of: said PEI comprises a branched PEI, said branched PEI comprises a branched alkylated PEI, and said branched alkylated PEI comprises an alkyl chain of 12 carbon atoms at most.

7.-9. (canceled)

10. The nanoparticle of claim 1, further comprising a biologically active agent.

11. The nanoparticle of claim 1, wherein said non-covalently bound is electrostatically bound.

12. The nanoparticle of claim 1, wherein said polynucleotide comprises 100 to 350 nucleobases.

13. The nanoparticle of claim 1, wherein said polynucleotide comprises a plurality of polynucleotide types.

14. The nanoparticle of claim 1, wherein said polynucleotide comprises RNA.

15. The nanoparticle of claim 14, wherein said RNA comprises a double stranded RNA (dsRNA), and optionally any one of: said RNA comprises at least 70% complementarity to any one of: (i) at least one RNA molecule derived from a pathogen; and (ii) at least one RNA molecule derived from a plant cell, said pathogen is a plant pathogen, and said pathogen is a virus.

16.-18. (canceled)

19. A composition comprising a plurality of nanoparticles of claim 1, and an agriculturally acceptable carrier.

20. The composition of claim 19, wherein said plurality of nanoparticles is characterized by a polydispersity index (PDI) ranging from 1 to 1.5, and optionally wherein any one of: said plurality of nanoparticles is characterized by a mean Zeta potential ranging from −5 mV to 40 mV, said carrier is selected from the group consisting of: a solvent, a surfactant, a dispersant, a sticking agent, a spreading agent, a synergist, a penetrant, a compatibility agent, a buffer, a defoaming agent, a thickener, a drift retardant, and any combination thereof, and said composition being formulated for administration by spraying, drenching, dipping, soaking, injecting, or any combination thereof.

21.-23. (canceled)

24. A method for introducing a polynucleotide to a plant, the method comprising contacting said plant or a part thereof with a therapeutically effective amount of the nanoparticle of claim 1, thereby introducing a polynucleotide to the plant.

25. A method for preventing or treating a viral infectious disease in a plant, the method comprising contacting said plant or a part thereof with a therapeutically effective amount of the nanoparticle of claim 1, thereby preventing or treating a viral infectious disease in the plant.

26. The method of claim 25 wherein said viral infectious disease comprises grapevine leafroll disease (GLD), and optionally any one of: wherein said viral disease is induced by a virus belonging to the genus Ampelovirus, said viral disease is induced by a virus selected from the group consisting of grapevine leafroll associated viruses (GLRaV), and said viral disease is induced by the virus GLRaV-3.

27.-29. (canceled)

30. The method of claim 25, wherein said treating comprises reducing a titer of a virus inducing said viral infectious disease in the plant or a part thereof.

31. The method of claim 25, wherein said treating comprises reducing any one of: number of curled leaves of said plant, rate of downward curling or cupping of leaves of said plant, and a combination thereof.

32. The method of claim 25, wherein said contacting comprises spraying, drenching, dipping, soaking, injecting, or any combination thereof, said plant or said part thereof.

33. The method of claim 25, wherein said plant part comprises foliage of said plant.
